(19) United States
(12) Patent Application Publication
(10) Pub. No.: US 2022/0282577 A1
(43) Pub. Date: Sep. 8, 2022

(54) GROUND LOOP HEAT EXCHANGER

(71) Applicant: Robert Amborsky, Winnipeg (CA)

(72) Inventors: Robert Amborsky, Winnipeg (CA); Garry Cyrille Alfred VanDenBerghe, Victoria (CA)

(21) Appl. No.: 17/195,012

(22) Filed: Mar. 8, 2021

(51) Int. Cl. E21B 7/20; F24T 10/15; E21B 7/24; E21B 1/02

(52) U.S. Cl. CPC E21B 7/205; F24T 10/15; E21B 7/24; E21B 1/02; F24T 2010/53

(57) ABSTRACT

A method for installing a ground heat exchange pipe uses a drive mechanism driven downwardly by a drive head including an elongate drive mandrel for driving a portion of heat exchange pipe into the ground. The pipe is attached to an inserting tool connected to the drive mandrel so that the tool carries the portion of heat exchange pipe into the ground. The mandrel engages the inserting tool which includes a base and tie attached to a portion of the pipe and drives the inserting tool into unbroken ground to a finite depth and then the drive head extracts the mandrel for reuse on the next installation leaving the inserting tool behind with the heat exchange pipe. The inserting tool includes side components engaging the heat exchange pipe and protecting it from damage as the heat exchange pipe is driven into the ground. A fluid supply duct can be provided in the mandrel.

The present invention relates to a ground loop heat exchanger, methods of manufacturing same, methods of using same, equipment to insert a ground loop heat exchanger into the ground and methods of doing business. More particularly, the invention relates to a direct inserting ground loop heat exchanger, and methods of making and using same and tools to insert the ground loop heat exchanger into the ground, methods of making and using same.

### BACKGROUND OF THE INVENTION

Ground source geothermal heat pump systems use the ground's renewable energy to heat or cool buildings by efficiently moving heat out of and into the ground, and worldwide have been deemed an essential tool in the fight against climate change. The system has 3 main sub-systems: ground heat exchanger (GHE) system; heat pump system; and building distribution system. The GHE system transfers thermal energy too and from the ground, the heat pump system transfers thermal energy between the GHE system and the building distribution system, and the building distribution system passes heat energy too and from the building enclosure.

The primary items that make up a typical GHE system consist of at least one ground heat exchanger (GHE), a supply header pipe or duct, a return header pipe or duct, a liquid or gaseous heat transfer medium and a pump or fan respectively. The pipes or ducts are typically installed at a depth below the ground's frost line. The heat transfer medium is pumped through the supply header from the heat pump to a GHE, passing through it. The GHE facilitates heat transfer from the ground to the heat transfer medium within. The heat transfer medium then passes back to the heat pump via the return header creating a closed loop cycle. This invention relates specifically to the ground heat exchangers GHE.

The pipes or ducts used in both the GHE and the headers are sized to facilitate or impede the heat transfer from the medium to the ground by increasing the flow velocity causing turbulent flow or reducing the flow velocity causing laminar flow in the heat transfer medium, respectively. High-density polyethylene (HDPE) is the most common type of piping material used for ground heat exchangers, with decades of proven service for this application. Other less used pipe materials are Crosslinked polyethylene (PEX), Polyethylene of raised temperature (PE-RT) and Polypropylene pressure pipe (PP).

The type of GHE used will affect the heat pump system performance (therefore, the heat pump energy consumption), auxiliary pumping energy requirements, and installation costs. Choice of the most appropriate type of GHE for a site is usually a function of specific geography, available land area, and life cycle cost economics. Primarily, only two types of GHE designs are used, vertical and horizontal.

Prior art shown in FIG. 1 illustrates a sectioned elevational view of the ground showing the prior art for a vertical GHE installation 2 of an un-sectioned typical u-bend GHE 34. A rotational drilling process 4 with drilling head 11 with or without sonic vibration is used to produce a bore hole 10 from the ground's surface 7 to the bore hole bottom 16. Bentonite clay and water are commonly used as drilling fluid where the water takes away the drill tailings and the bentonite clay reinforce the bore hole wall 14. Not illustrated, depending on the stability of the ground 6 being drilled, a hollow steel casing might be driven with rotation, down force, and vibration to the bedrock elevation prior to drilling out the ground accumulated inside the casing and drilling into the bedrock. After completion of bore hole 10, a u-bend GHE 34 is inserted with a weight 66 fastened with weight tie 64 to the u-bend reversing fitting 54 to assist in pulling the u-bend GHE 34 down into bore hole 10 and keep it from floating if there is water present in the hole.

Not shown, the u-bend GHE 34 is usually delivered to the installation site traverse wound onto a steel reel like string is wound in layers onto a wooden or plastic bobbin. The winding of the u-bend GHE around the reel creates a spring force in the pipe due to the bending of the pipe with the pipe wanting to return to its straight form like a clock spring wants to spread open. To compensate for this clock spring reaction, GHE pipe suppliers' tape or strap every layer of GHE pipe on the reel, to the reel, so that the entire GHE does not spring open randomly in transport or installation but makes the GHE pipe difficult to unwind quickly and/or with automated equipment. If allowed to spring open on the reel the GHE becomes very difficult to handle and install into the bore hole. As the GHE pipe is unwound from the reel the tape or strap holding the current layer being unwound is removed freeing the pipe slowing the installation of the GHE.

Referring to prior art FIG. 1 a description of the u-bend GHE 34 is as follows. Pumped, heat transfer medium is transported to the u-bend GHE 34 via supply header pipe 8 and enters u-bend GHE 34 via GHE pipe inlet 42 traveling into a descending pipe 46 that descends into the bore hole 10 and is connected to u-bend reversing fitting 54, which reverses the heat transfer medium flow back upwards. U-bend reversing fitting 54 is connected to ascending pipe 56 and the heat transfer medium exits u-bend GHE 34 at GHE pipe outlet 60 passing into return header 9.

Commonly, as the u-bend GHE 34 is being inserted into the bore hole 10, a grouting hose not shown is loosely attached to u-bend reversing fitting 54 and grout 18 is pumped from the bore hole bottom 16 displacing any water and air up out of the hole till the grout 18 reaches the ground surface 7. The grout hose is pulled up out of the bore hole 10 while still pumping grout 18 to fill any space left by its own volume.

Referring to prior art FIG. 1, for optimal heat transfer performance, the u-bend GHE 34 needs to be located symmetrically in the bore hole 10 with shank spacing 26 between descending pipe 46 and ascending pipe 56 consistent at the designed amount. Shank spacers 38 are used to achieve constant shank spacing 26 but affect install time and cost and are seldom used in practice. The u-bend GHE 34 inserting and grouting process can create situations where the u-bend GHE 34 has no shank space 32 between the ascending pipe 56 and the descending pipe 46 which amplifies thermal short circuiting of the GHE, leaves air pockets 24 which create heat transfer resistance between the ground and u-bend GHE 34 and excess grout 20 creating higher thermal resistance between the GHE pipe and the ground 6, all reducing the thermal heat transfer efficiency of u-bend GHE 34.

Prior art FIG. 2 illustrates a section elevation view of the less used concentric GHE 35 that has been driven into the ground so there is no grout and illustrates the inner working of the GHE. The concentric GHE 35 consists of a large diameter outer descending pipe 47 with the lower end sealed with an end cap 55 and a smaller diameter inner ascending pipe 57 placed inside the outer descending pipe 47. A built in or add on concentric pipe spacer 40 is used to centre the smaller inner ascending pipe 57 inside of the larger outer descending pipe 47 to prevent thermal short circuiting of the inner ascending pipe 57 with the inner wall of the outer descending pipe 47. A gap is left between the end cap 55 of the outer descending pipe 47 and the open end of the inner ascending pipe 57 creating a concentric reversing space 50 to allow heat transfer medium flowing down the large outer descending pipe 47 to reverse flow up the small inner ascending pipe 57. At the head of the bore hole, a tee fitting 44 seals the tops of inner ascending pipe 57 and outer descending pipe 47 together allowing separate flow down into the descending pipe 47 and up out of the ascending pipe 57. Compared to the u-bend type GHE, the concentric GHE is more complex requiring additional special parts and assembly thus adding to the cost of the GHE installation.

For vertical pipe GHEs in general, u-bend GHEs have pipes that range from 0.75 to 1.5 inches in nominal diameter, concentric GHEs have pipes usually not exceeding 4 inches in nominal diameter, and bore depths vary from 15.2 to 183 m (50 to 600 ft), depending on local drilling conditions and available equipment. Multiple wells are typically required, with well spacing not less than 4.6 m (15 ft) in northern climates and not less than 6.1 m (20 ft) in southern climates to achieve the total heat transfer requirements. After the vertical GHEs are installed, horizontal trenches are dug usually to a depth not lower than where it requires shoring for safety, between the GHEs and the building where the heat pump is installed. These trenches are used to lay pipe used to carry the heat transfer medium used in the GHEs to and from the heat pump and are later filled in with ground.

Geothermal energy baskets are made of spiral wound HDPE pipes that are fastened with a metal or wooden skeleton. The chosen dimensions of the baskets are dependent on the available space and the geological conditions of the soil. After having evaluated the size, the baskets are installed at a depth below the frost line to prevent the baskets from freezing damage. These helical coil heat exchangers have the benefit of increased pipe volume per unit depth, which increases the amount of heat that can be transferred for a given depth. This allows for shallow heat exchangers that do not require borehole drill rigs. However, a challenge for this approach is the current capability to drill moderately deep holes (5-15 meters) at large diameters (greater than 0.3 meters). A study by the “Cheap-GSHPs” project developed a technique called “Enlarged Easy Drill” to accomplish this in a cost-effective manner. Results from this study indicate that heating and cooling loads can be handled by basket heat exchangers installed using this technique. The study also found that backfilling with a material with relatively high thermal conductivity can have a significant impact on the temperature response of the heat exchanger. This is because the temperature response of the basket heat exchanger is highly sensitive to the thermal conductivity. It has a much smaller heat transfer capacity than the u-bend GHE, so several basket GHEs are required to meet the same loads as a single borehole with u-bend GHE.

### RELATED ART

As with u-bend GHE concentric GHEs can be installed into boreholes 10, prior art FIG. 1 with grout or inserted into the ground as shown in prior art FIG. 2 and explained in prior art US20130087306 Winn published Apr. 11, 2013 [306] and US20170268803A1 Cauchy published Sep. 21, 2017 [803].

In their attempt to increase the thermal efficiency of the concentric GHE and reduce the installation time and cost prior art [306] and [803] both use the concentric GHE configuration and insert the outer descending pipe with capped end into the ground first then add the inner ascending pipe with spacer and Tee fitting afterwards. In both applications the descending pipe end cap is conical with [803] adding end cap ports for cutting fluid to facilitate easier penetration into the ground. The direct contact of the descending GHE pipe with the ground will facilitate increased heat transfer between the heat transfer medium and the ground because there is no extra grout or air pockets to resist thermal transfer. [306] increases thermal transfer further by making the descending pipe out of high thermal conductive materials like metals. The short-coming of these designs are as follows. The GHE length and inserting depth is limited by the ability of the outer descending pipe 47, prior art FIG. 2 material to resist the compressive force exerted on the pipe while its being inserted in the ground. The forces exerted on the outer descending pipe 47, prior art FIG. 2 are directly influenced by the mass of the inserting machine, the strength and velocity of the inserting mechanism mounted to that machine and the ground's inserting resistance. Therefore, the ground's soil makeup will directly influence the depth that the GHE can be inserted thus limiting where the GHE can be installed. With stronger and thermally conductive materials [306] being required would be an additional cost to the cost concentric GHEs already have over u-bend type GHEs. Inserting the GHE into the ground should reduce installation time for the inserting itself, but it is questionable if the increased time needed to completer the concentric GHE assembly negate the time saving when compared to a u-bend type GHE installation.

Another method of installing a concentric GHE is described in prior art U.S. Ser. No. 10/641,051 B1 Gradwold assigned to Dandelion Energy and issued May 5, 2020 [051]. Prior art [051] modifies the concentric GHE 35, prior art FIG. 2 by replacing the end cap 55, with a boring air hammer boring head and uses this boring head to pull the larger outer descending pipe 47 into the ground. This is done by placing an actual air hammer boring tool inside of the outer descending pipe 47 temporarily locking both boring heads together so they act as one and activating the air hammer boring tool to insert the boring head type end cap into the ground. After the required depth is achieved, the two boring heads are disconnected from one another and the boring tool is removed from the outer descending pipe 47 and can be used for another installation. A similar system is used with prior art U.S. Pat. No. 9,217,292B2 [292] where an air hammer boring tool is used. In [292] the boring tool is made with the larger outer descending pipe 47 of the concentric GHE 35 and is made cheap enough that it would only be used once and left in the ground complete. An additional piece of equipment that can be used with [051 and 292] to aid with the hammer boring tool action is described in prior art 10,316,588 [588] which is a method of vibrating the larger outer descending pipe 47 to minimize friction between the ground and the outside of the larger outer descending pipe 47 so that the boring head can pull the outer descending pipe further into the ground. The short comings of these pipe pulling devices are:

-a- the correct design and manufacturing of the connection between boring head and the larger outer descending pipe 47, prior art FIG. 2 of our application, must be such that it can withstand the continuous pounding of the air hammer and maintain a pressure seal for when it will be used with heat transfer medium, the patents mention secondary measures and using sealants pumped into the boring head in the instance where the original seal is compromised or as a precaution;

-b- the apparatus once on its way into the ground may not travel in the direction first pointed causing adjacent GHE installations to cross paths or get close enough to one another to diminish thermal performance;

-c- the added parts and steps required to assemble the concentric GHE after inserting would be more costly than a u-bend GHE installation;

-d- the added cost of making and assembling a boring head to the larger outer descending pipe 47 prior art FIG. 2 of this application or leaving a hammer boring tool in place after installation are large additional cost; and

-e- the apparatus being used are small and limited in the driving power they can achieve because they are constrained in size by the size of the outer descending pipe 47, prior art FIG. 2 of this application.

The present invention may provide an apparatus and method which may solve one or more of the following list of problems in the existing art:

High costs associated with bore hole:

Drilling labour and equipment

Mixing cutting fluid and grout labour and materials

Pumping grout labour and equipment

Separating tailings from water labour and equipment

Hauling tailings away labour and equipment

Installing GHE labour and equipment

Installing and removing hole reinforcing steel casings labour and equipment

Site clean up labour and equipment.

Issues with thermal conductivity due to:

U-bend GHE pipes contacting each other in the bore hole causing thermal short circuiting.

Heat transfer resistance of grout between the u-bend and concentric GHEs and the ground

Damage to direct ground contact concentric GHE during installation requiring repair or abandonment of the GHE.

Installation limitation depth due to power available to install direct ground contact concentric GHE.

Extra time and associated cost assembling concentric GHE after outer descending pipe is installed.

Extra cost associated with metallic materials used for concentric GHE.

Extra cost associated with complex specially GHE designs.

High cost and thermal inefficiency of installing basket GHEs.

Drilling or digging equipment and labour

Hauling tailings away labour and equipment

Installing GHE labour and equipment

Back filling labour material and equipment

Site clean up labour and equipment.

Back fill thermal resistance with ground.

Uncontrolled or poorly controlled above ground GHE assembly or GHE pipe handling slowing the installation process and is a safety hazard.

High cost, low seal reliability, uncontrollable inserting direction, and the limited inserting power of special concentric GHE end caps to install the GHE in direct contact with the ground.

### SUMMARY OF THE INVENTION

According to one aspect of the invention there is provided a method for installing a ground heat exchange pipe in ground comprising:

using a drive mechanism including an elongate drive mandrel for driving a portion of heat exchange pipe in a generally downward direction into the ground;

engaging and carrying the heat exchange pipe by an inserting tool connected to the drive mandrel as the portion of heat exchange pipe is driven into the ground;

where the inserting tool carries the portion of heat exchange pipe into the ground during its installation;

where the mandrel of the drive mechanism engages the inserting tool carrying the heat exchange pipe and drives the inserting tool into the ground to a finite depth then extracts the mandrel for reuse on the next installation leaving the inserting tool behind with the heat exchange pipe.

According to one aspect of the invention there is provided an apparatus for installing a ground heat exchange pipe in ground comprising:

a drive mechanism including an elongate drive mandrel for connection to a drive head for driving of the drive mechanism in a generally downward direction into the ground;

an inserting tool connected to the drive mandrel as the drive mandrel is driven into the ground;

the inserting tool including a coupling which engages and carries a portion of heat exchange pipe into the ground during its installation;

where the mandrel of the drive mechanism engages the inserting tool carrying the heat exchange pipe and drives the inserting tool into the ground to a finite depth then extracts the mandrel for reuse on the next installation leaving the inserting tool behind with the heat exchange pipe.

The arrangement therein can be used to install heat exchange pipes of U-shape with two pipe portions connected by a U-bend and coaxial constructions using relatively small installation tools guiding the pipe arrangements. The same method can also be used with more complex assembly of pipe including linear arrays and cylindrical arrangements where a different shape of installation or guide tool is used to support and protect the pipes as they are forced into the ground.

In accordance with one preferred embodiment, the inserting tool is driven into unbroken ground without requirement for a pre-formed hole and wherein the inserting tool includes components engaging the heat exchange pipe and protecting it from damage as the heat exchange pipe is driven into the ground.

In accordance with one preferred embodiment, the reusable mandrel of the drive mechanism and the inserting tool are connected to one another during the driving into the ground working together to install heat exchange pipe.

In accordance with one preferred embodiment, the mandrel is the same length as the install depth of the heat exchange pipe.

In accordance with one preferred embodiment, there is provided a pipe dispensing device which carries and dispenses heat exchange pipe onto the inserting tool in a controlled fashion.

In accordance with one preferred embodiment, the pipe dispensing device includes two supplies to supply ascending and descending pipe portions respectively in parallel position as the mandrel is driven into the ground.

In accordance with one preferred embodiment, the drive mechanism, the pipe dispensing device and the mandrel are mounted together to form an installer head that is mounted onto a driver head.

In accordance with one preferred embodiment, the inserting tool includes an anchor which has a front head which is forced into the ground and protects leading parts of the heat exchange pipe from abrasive damage caused from passing through the ground.

In accordance with one preferred embodiment, the mandrel includes guides engaging and protecting the trailing heat exchange pipe as the pipe moves into the proper position in the ground.

In accordance with one preferred embodiment, the heat exchange pipe includes ascending and descending portions with a u-bend coupling at the inserting tool.

In accordance with one preferred embodiment, the mandrel includes guides comprise side walls defining guide channels for the descending and ascending pipe portions.

In accordance with one preferred embodiment, the inserting tool includes a tie for attachment to the bottom u-bend coupling of the heat exchange pipe.

In accordance with one preferred embodiment, the heat exchange pipe is inserted to a depth where the heat exchange pipe has an inlet/outlet above the ground surface for connection to header pipes to and from a pump.

In accordance with one preferred embodiment, the mandrel is a rigid elongate member that has a leading mandrel toe for releasable attachment to the inserting tool and a trailing mandrel head for engagement with and receiving driving forces from a drive head.

In accordance with one preferred embodiment, the drive head includes a vibratory hammer.

In accordance with one preferred embodiment, the mandrel has a cross-sectional shape which is sized and configured to have a shank spacer that maintains a shank distance between the descending pipe and the ascending pipe during the inserting of the inserting tool and extraction of the mandrel.

In accordance with one preferred embodiment, the mandrel has a cross-sectional shape configured to allow the heat exchange pipe to placed inside the mandrel whereby the mandrel outside surface is the only surface in contact with the ground thus shielding the heat exchange pipe from the ground during inserting.

In accordance with one preferred embodiment, the mandrel is arranged to be clamped at any point along its length and step driven by the drive head so that the drive head is clamped at a starting position for an initial driving stroke, unclamped from the mandrel and moved to carry out series of strokes driving the inserting tool into or out of the ground.

In accordance with one preferred embodiment, the mandrel toe has raised portions of the mandrel toe perimeter to provide mandrel alignment tabs that align with and fit into notches or cut-outs in the inserting tool where the anchor alignment notches, and the mandrel alignment tabs align the anchor to the mandrel and prevent any lateral movement of the anchor during inserting of the inserting tool.

In accordance with one preferred embodiment, the mandrel has a hollow cross section that can be used to carry a lubricant or high-pressure cutting fluid or which can also be used to pump grout in the installation during the mandrel extraction,

In accordance with one preferred embodiment, the mandrel includes a plurality of mandrel lengths which are guided and stored in a mast that is part of the driver head that can be spliced together to form one continuous length and thus allow deeper installation.

In accordance with one preferred embodiment, the inserting tool has a tie down point that allows for an anchor tie to be fastened to it and the heat exchange pipe to pull the heat exchange pipe into the ground with it and anchor the heat exchange pipe in place during the extraction of the mandrel from the ground.

In accordance with one preferred embodiment, a bar anchor has a length that is equal to or longer than a cross-sectional width of a mandrel which fastened to the anchor bar by simply wrapping around its cross-section at any point within the width of the mandrel that it traverses.

In accordance with one preferred embodiment, a plate anchor is made up of a top surface, a parallel bottom surface and an edge where the two surfaces come together at the anchor perimeter so that the anchor bottom is against the surface of the ground, the anchor top is in contact with the mandrel toe, and the mandrel tie has tied the plate anchor to the heat exchange pipe.

In accordance with one preferred embodiment, in order to displace the ground more easily during inserting the plate anchor has a point in the form of a cone or pyramid added to the anchor bottom.

In accordance with one preferred embodiment, the driver head includes a positive driver that can insert and extract the inserting tool into and out of the ground without any slippage.

One or more of the above-listed disadvantages may be solved or ameliorated by the arrangement as described hereinafter, respectively as follows:

Lower compared costs associated with the invention:

Installing labour and equipment, with labour being no more then 2 operators and installation times reduced by at least an order of magnitude.

No GHE weight required to hold down the GHE in a flooded hole.

Site clean up labour and equipment.

Issues with thermal conductivity due to:
bend GHE pipes are held apart during installation by a shank spacer and remain set apart in the ground.

GHE pipes are in direct contact with the ground no grout is used therefore there is no extra thermal resistance between the GHE pipe and ground maximizing thermal conductivity.

GHE are not stressed during installation and some or all parts of the GHE can be shielded from the ground during inserting using a mandrel.

An inserting/extraction mechanism is mounted on any size mobile equipment and installation power/driving force that can be employed is limited by the weight of that mobile equipment and the capability of the inserting/extraction mechanism.

Concentric GHE can be installed with this invention at reduced costs up until the assembly required to finish the GHE. Based on installation cost, the invention should make concentric GHEs obsolete.

The invention can be used to install GHEs made of any materials.

Common GHE designs can be used but new ones will be developed based on the paradigm shift this idea present.

Installing basket GHEs.

Installing labour and equipment labour being 1 to 2 operators

Site clean up labour and equipment.

GHE pipes are in direct contact with the ground.

The arrangement of this invention simplifies the installation of ground heat exchangers (GHE) used in ground source heat pump heating and cooling systems used in buildings and industrial processes. For ground formations made of silt/sand/clay/gravel excluding bedrock the invention is a novel way vertical GHEs, basket GHEs and new designs of GHEs can be installed quickly and efficiently and opens many possibilities for more new designs of GHEs and GHE systems.

Specific to u-bend GHEs, the invention can eliminate the bore hole diameter constraint on the u-bend reversing fitting size thus allowing for larger radius u-bends that would reduce the pressure drop across the fitting thus reducing the heat transfer medium pumping power needed and increasing the shank spacing thus increasing the thermal performance of the u-bend GHE.

The invention consists of two main parts, drive mechanism (CEM) used for driving an extracting and an interchangeable inserting or extraction tool (CET) for the heat exchange pipe (GHE), with or without a pipe dispensing mechanism (PDM), preferable with a PDM. The CET carries a GHE into the ground during its installation, protecting it from damage and aligning its pipes during the process. The CEM inserts the CET carrying the GHE into the ground a finite depth then extracts part of the CET called the mandrel for reuse on the next installation leaving other parts of the CET behind with the GHE. The CEM and the reusable CET mandrel are integral to one another working together to install GHEs. Simultaneously the PDM carries and dispenses GHE pipe or assembled GHEs onto the CET in a controlled fashion. The mandrel is the same length as the install depth of the GHE. The CEM, PDM and CET mandrel are mounted together to forma GHE installer head that is mounted onto any prior art mobile equipment.

### CET

The CET consists of a long slender stiff mandrel, a consumable anchor and a consumable anchor tie and is used to carry a GHE into the ground, position it and retain it there. To better understand the details of the CET a brief explanation of how the CET, CEM and PDM work together is as follows. Using the anchor tie, the anchor is attached to the part of a GHE that will be installed the deepest in the ground. The mandrel, that is approximately the same length as the install depth of the GHE, is used to insert the anchor a set depth into the ground pulling the GHE with it. As this is happening, the anchor in all but one configuration of the invention protects the leading parts of the GHE from abrasive damage caused from passing through the ground and the mandrel guides the trailing GHE pipes or pipe into the proper position in the ground. If present the PDM controls the transfer of GHE pipe to the mandrel. The GHE is only inserted to a depth where the GHE pipe inlet/outlet is above the grounds surface for connection to prior art header pipes to and from a pump. After the inserting is complete the mandrel is extracted from the ground by the CEM with the anchor and anchor tie securely set in the ground holding the GHE from being extracted along with the mandrel. If the PDM is dispensing fully assembled GHEs the installation is complete after the mandrel is extracted else the GHE pipe or pipes are cut leaving enough excess length to attach to the prior art header pipes.

The mandrel is a rigid elongated member that has a leading surface called a mandrel toe and a trailing surface called a mandrel head. The mandrel can have a hollow cross section having an inner and outer perimeter thus forming along the mandrel's length a mandrel inside surface and a mandrel outside surface or not having a hollow cross section but having only an outer perimeter and therefore only a mandrel outside surface formed along its length.

The mandrel can be made of a single cross-sectional shape or combination thereof fixed together along their lengths, preferable common structural steel shapes and bar cross sections. This cross-sectional shape flexibility allows the mandrel to be adapted to many existing and future GHE designs. The mandrel can be made from any rigid material with good compressive strength and abrasion resistant characteristics, preferably metal, preferably steel, preferably structural steel. The mandrel cross-sectional shape is sized and configured to: have the strength to resist the loads exerted on it during inserting and extraction of the CET loaded with a GHE; have a moment of inertia that resists bending in all directions; takes up a boundary area just large enough to carry the GHE thus minimizing resistance from the ground during inserting, preferably large enough to carry a GHE made with pipes that range from 0.75 to 1.5 inches in nominal diameter for u-bend GHEs and up to 4 inches nominal diameter for concentric GHEs; and can accommodate, u-bend GHEs, concentric GHEs and basket GHEs. For u-bend GHEs the mandrel cross-sectional shape is sized and configured to have a shank spacer that maintains the shank distance between the descending pipe and the ascending pipe during the inserting of the CET with u-bend GHE and extraction of the CET mandrel. The shank spacer can be an elongated member with cross-sectional size approximately equal to the shank space of the u-bend GHE when the u-bend GHE is fitted on the outside of the mandrel or can be a pin of any shape, with at least one placed near the toe of any hollow mandrel that bisects the shank space of the u-bend GHE and maintains it when the u-bend GHE comes out of the hollow mandrel as the mandrel is being extracted from the ground leaving the u-bend GHE held in place by the anchor.

When ground materials are highly abrasive, the mandrel's cross-sectional shape is configured into a hollow cross section having an inner and outer perimeter thus forming along the mandrel's length a mandrel inside surface and a mandrel outside surface with the GHE being place inside the mandrel whereby the mandrel outside surface is the only surface in contact with the ground thus shielding the GHE from the ground during inserting of the CET carrying it. Mandrels are configured for different CEMs and there are two methods the CEM can exert positive driving force on the mandrel so that it can insert and extract the CET into and out of the ground. The first method of exerting the positive driving force is directly and centrally on the mandrel head surface thus directing the force through the mandrel's length to the mandrel toe. The second method of exerting the positive driving force is through the side of the mandrel at a point anywhere along its length and this second method can be broken down into two sub methods which consist of driving the mandrel with or without a positive drive incorporated into at least one side of the mandrel. The first sub-method for the positive driver to exert force on the mandrel through its side, at a point any where along its length, is by incorporating into the mandrel a positive drive which directly interfaces with the CEM's positive driver. The incorporated mandrel positive drive can be of a type used in any common linear actuator or combination thereof gear-teeth/chain-links/etc. and be incorporated into at least one mandrel outside surface or edge, it being preferable to have the mandrel positive drive incorporated into two apposing mandrel outside surfaces or edges in order to center the driving force on the mandrel, it also being preferable that the mandrel positive drive is like the rack part of a rack and pinion drive, i.e. a multitude of teeth or raised sections spaced equally along the length of the mandrel it is also preferable that the positive drive have a high tolerance for contamination by ground material and not be easily fowled and jammed by these materials. It is important that the positive drive works with the CEM to exerts a constant inserting or extracting force on the CET when in operation so that if a vibratory hammer is included in the CEM there is effective transfer of vibrations into the CET. The second sub-method for the positive driver to exert force on the mandrel through its side at a point any where along its length is used when the mandrel comes without a prior mentioned incorporated mandrel positive drive. For this second sub-method the mandrel's cross-sectional shape must be such to allow it to be clamped at any point along its length and step driven by the CEM's positive driver. The CEM's positive driver would be clamped at a starting position along the CET's mandrel's length, would insert the CET into or out of the ground a limited distance, unclamp from the mandrel, return to the starting position and repeat those steps thus inserting or extracting the CET into or out of the ground.

Raised portions of the mandrel toe perimeter called mandrel alignment tabs can be made in the mandrel that align with and fit into notches or cut-outs made in a mentioned later plate anchor called anchor alignment notches. The anchor alignment notches, and the mandrel alignment tabs align the anchor to the mandrel and prevent any lateral movement of the anchor during inserting of the CET.

The mandrel inside of a mandrel with a hollow cross section can be used to carry a fluid. The fluid carried by the mandrel inside can be a lubricant or high-pressure cutting fluid used to aid in the inserting of the CET with GHE. The mandrel inside can also be used to pump grout if deemed necessary in the installation during the mandrel extraction, especially important if regulators deemed the GHE installation would somehow create a path for water to flow up or down the outside of the GHE. During CET inserting into the ground the fluid pressures on the mandrel inside must be equal or greater than the opposing ground pressure caused by inserting of the CET to prevent the ground from entering the mandrel inside. As mentioned later, the anchor type used will also play a part in the use of fluids.

When not inserted in the ground mandrel lengths are guided and stored in a mast that is part of the GHE installer head. The mast is higher than the vertical length of the mandrel and can be used to house multiple mandrels that can be spliced together to form one continuous length and thus allow deeper inserting of the CET carrying the GHE. An automatic mandrel splicer can be incorporated to efficiently splice and un-splice mandrels.

Two types of anchors can be used in an CET, a bar anchor or a plate anchor. The anchor has a tie down point that allows for an anchor tie to be fastened to it and the GHE. The anchor is used to pull the GHE into the ground with it and anchor the GHE in place during the extraction of the mandrel from the ground.

The bar anchor can be made of any bar with a concentric cross-sectional shape square/round/hexagonal/etc. and a length that is equal to or longer than any cross-sectional width of a mandrel. The bar fits into notches made in the mandrel toe on either side of the width that is to be traversed by the bar. The anchor tie is fastened to the anchor bar by simply wrapping around its cross-section at any point within the width of the mandrel that it traverses. The bar anchor is preferably used to allow fluid lubrication/cutting/grouting to pass by it during the inserting or extraction of the CET.

The plate anchor is made up of a top surface called the anchor top, a parallel bottom surface called the anchor bottom and an edge where the two surfaces come together called the anchor perimeter with an anchor thickness being the parallel distance between anchor top and the anchor bottom. When assembled into a CET ready to be inserted with a GHE into the ground the anchor bottom is against the surface of the ground, the anchor top is in contact with the mandrel toe, and the mandrel tie has tied the plate anchor to the GHE. The plate anchor can be made from rigid or semi-flexible materials, if semi-flexible preferably sheet metal, preferably steel, if rigid preferably steel, and is shaped to protect the attached end of the GHE during installation. Any suitable part of the anchor can be used to fasten the anchor tie to, preferably an anchor tie down consisting of a loop that is permanently fixed to the anchor. The anchor bottom surface area is sized to minimize the force required to insert it into the ground and anchor cut outs can be provided in some instances to do just that and allow the ground to flow easier around the anchor perimeter edge and closer to, the mandrel and GHE pipe if the GHE is on the mandrel outside or mandrel if the GHE is on the mandrel inside, as the CET with GHE is inserted into the ground. To displace the ground more easily during inserting the plate anchor can have a point in the form of a cone or pyramid added to the anchor bottom. Anchor cut outs can also be used to allow fluids to pass by the anchor during inserting of the CET.

Notches can be made around the plate anchor perimeter or cut outs can be made in the anchor surface called anchor alignment notches that line up with and allow the inserting of mandrel alignment tabs made in the mandrels toe around its parameter. The anchor alignment notches, and the mandrel alignment tabs align the anchor to the mandrel and prevent any lateral movement of the anchor during inserting of the CET.

The anchor tie is used to fix the anchor to the GHE and can be done by any means that assures that the GHE stays attached to the anchor during the entire inserting of the CET and holds the GHE to the anchor whilst the CET mandrel is being extracted.

The inserting or extraction mechanism CEM consists of a positive driver that can insert and extract the CET into and out of the ground without any slippage between the CEM and CET. The positive driver can be any type of common linear actuator or combination thereof and/or vibratory hammer, preferably a mechanical or hydraulic positive driver with a vibratory hammer. If hydraulic positive driver, preferably a hydraulic cylinder inserting or extracting the CET directly or indirectly with the vibratory hammer clamped in a way to the CET for effective transfer of vibrations. A mast mounted to GHE installer head is used to house any hydraulic cylinder based CEM. If mechanical positive driver is used, preferably a rack and pinion linear type drive, with the pinion gear or sprocket being the positive driver's prime mover working with a matching rack being the positive drive incorporated into the CET's mandrel to insert and extract the CET into and out of the ground. A preferable CEM with a mechanical positive driver would have at least one rotational pinion prime mover, preferably two or more mounted to drive two rack type drivers along opposing sides or edges of the CET mandrel centering the driver force on the mandrel. It is important that the CEM positive driver and the CET positive drive work together to exert a constant inserting or extracting force on the CET when in operation so that any vibratory hammer fixed to the mechanical positive driver can effectively transfer vibrations through the rack and pinion to the CET. Like mentioned with the mandrel it is preferable that the positive driver have a high tolerance for contamination by ground materials and not be easily fowled and jammed by these materials. If mechanical the linear actuator and vibratory hammer can be driven by any type of rotary motor, preferably hydraulic.

The pipe dispensing mechanism (PDM) is made up of common available mechanical and electronic parts that work together as a system to carry and dispense GHE pipe or assemblies in a controlled manner. The parts of the PDM are all mounted in various ways to the GHE installer head. The PDM is best described as it supplies a single GHE pipe to a mandrel. Pipe is pulled off a pipe reel with a long length of pipe wound upon it. The pipe is pulled by an anchor that the leading edge of the pipe is attached too using an anchor tie. The anchor is being inserted into the ground by a mandrel being driven by the CEM. The pipe is guided to and positioned along side or inside of the mandrel by a pipe final guide and wraps around the guide. The guide can be made up by any means that allows the pipe to freely traverse over the guide. The guide is mounted to a common load cell transducer called a brake transducer mounted to the GHE installer head. The brake transducer measures the force of the pipe traversing over the final guide and sends an electronic signal to a controller that converts the force into a relative pipe axial tension. A final guide clamp mounted to the GHE installer head is used to clamp the GHE pipe to the final guide preventing the pipe from moving when ever the GHE pipe is not being pulled. The pipe is guided to the final guide by one of two other guides, the reel diameter guide and the pipe helix guide. These guides can be made up by any means that allows the pipe to freely traverse over them at the same time positioning the pipe. The pipe helix guide guides the pipe coming off the pipe reel and compensates for any horizontal lateral movement of the pipe caused initially by the pipe being traverse wound onto the pipe reel or the pipe being loose on the reel. The reel diameter guide guides the pipe coming off the pipe reel and compensates for any vertical movement of the pipe caused by the change in the pipe wound on the pipe reel's outer diameter as it is unwound. The pipe reel is mounted onto a reel shaft and held to it by a reel shaft collar. The reel shaft is mounted through a free spinning bearing that is mounted to a reel support beam that is mounted on the GHE installer head. A reel brake is coupled to the reel shaft, fixed to the reel support beam. The reel brake is used to restrict the pipe unwind, controlling the rate it turns and rate it supplies pipe to the mandrel. The reel brake used can be a friction type brake or can be a motor with both being controlled by an electronic controller with the axial tension feed back input coming from the brake transducer mounted to the pipe's final guide. The electronic controller, brake transducer, and reel brake form a closed loop system that can be set to monitor and control the axial tension placed into the pipe coming off the pipe reel and being installed into the ground. When ever the GHE pipe is not being pulled the final guide clamp is activated and prevents the GHE pipe from moving thus maintaining the axial tension in the pipe caused by the brake and allows the cutting of the pipe after the GHE has been installed. With the axial tension being maintained the pipe wound on the reel cannot open like a clock spring so tapping or strapping of every wound layer of pipe on the reel is not required.

For the inserting of CETs with mandrels that are oversized and too large to fit in any positive driver, like for example installing basket GHEs, these CETs can be inserted with a slight change in the CEM where a mandrel beam or multiple thereof is used to span the largest cross-sectional dimension of the oversized mandrel. The mandrel beam has multiple mandrel beam mandrel clamps that fix the head of the oversized mandrel to the mandrel beam. The mandrel beam also has a mandrel beam driver clamp that is fixed to a mandrel beam driver. The mandrel beam driver is configured the same way as a normal mandrel with a positive drive incorporated into it and can fit into and is compatible with any positive driver. To insert the CET into the ground with this arrangement the mandrel driver inserts the mandrel bean driver using inserting force from a hydraulic or mechanical positive driver with or without vibratory hammer force. The mandrel beam in turn inserts the CET into the ground. Because of the mandrel beam driver clamp and the mandrel bean mandrel clamp any vibrational force will be transferred to the CET with this arrangement. Because of the increase inserting resistance CETs with oversized mandrels can create the depth that they can be installed too will be less compared to the mandrel mentioned earlier.

### BRIEF DESCRIPTION OF THE DRAWINGS

FIG. 1 is a prior art illustration of an arrangement for inserting a GHE.

FIG. 2 illustrates a Prior art section elevation view of the less used concentric GHE 35 that has been driven into the ground so there is no grout and illustrates the inner working of the GHE.

FIGS. 3A to 3D shows a sectioned front elevational view, a side elevational view, a cross sectional plan view and detail view of a prior art u-bend GHE.

FIGS. 4A to 4G illustrate a perspective view, a front elevational view, a full section elevational view, a plan view, a detail half sectional view, a detail cross sectional view and a detail view of the preferred mechanism for installing GHEs.

FIGS. 5A to 5F illustrate six elevational views of various other GHE installer head configurations of the above using other types and amounts of mechanical drives and the using of lubrication to assist inserting.

FIGS. 6A to 6F illustrate the GHE installer head mounted to mobile equipment and going through one complete u-bend GHE installation in perspective view with the ground in half section.

FIGS. 7A to 7D show a perspective view, a front elevational view, a half section elevational view and a cross sectional plan view of one embodiment of a mandrel.

FIGS. 8A to 8D show a perspective view, a plan view, an elevational view and a cross sectional plan view of one embodiment of a mandrel.

FIG. 8E shows a front section elevational view with cut out of this arrangement in use extracting the mandrel from the ground 6

FIGS. 9A to 9C show a perspective view, a front elevational view and a cross sectional plan view of one embodiment of a mandrel.

FIGS. 10A to 10C shows a perspective view, a partially sectioned front elevation view and a cross sectional plan view of a built-up tool and mandrel.

FIGS. 11A to 11C shows a perspective view, a full sectioned front elevational view and a cross sectional plan view of one embodiment of a mandrel.

FIGS. 12A TO 12C illustrate a perspective view, a front full sectional elevational view and a cross sectional plan view of one embodiment of a mandrel.

FIGS. 13A to 13C illustrate a perspective view, a front full elevational view and a cross sectional plan view of one embodiment of a mandrel.

FIGS. 14A to 14D show a perspective view, a top plan view, a front elevational view, and a bottom plan view of one embodiment of a mandrel.

FIGS. 15A to 15E show a perspective view, an exploded perspective, a half section elevational view, a plan view and a detail partial section view of a large hollow cylinder mandrel.

FIG. 15F shows the spiral basket pipe arrangement as it would be installed into the ground with the mandrel removed.

FIG. 16 shows a perspective view of an installer head mounted to mobile equipment's installing a spiral basket pipe arrangement.

FIG. 17 shows a perspective view of an installer head mounted to mobile equipment installing a planar multi-u-bend pipe arrangement.

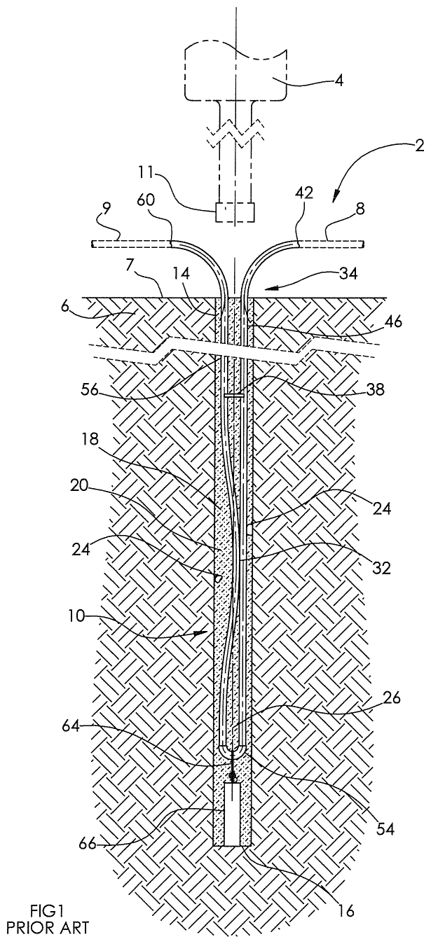

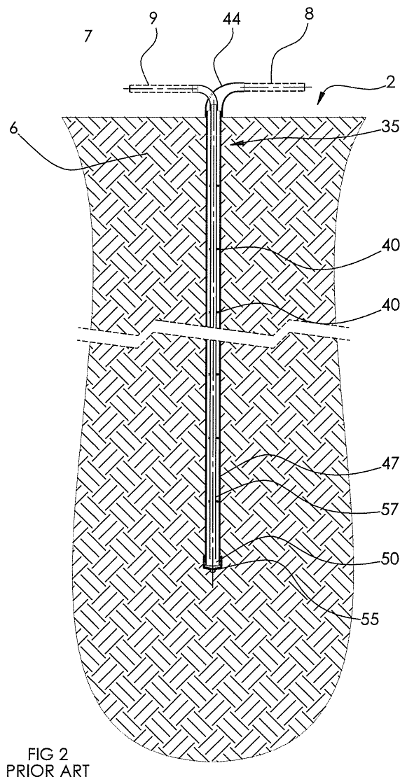

### DETAILED DESCRIPTION

Because of our invention all surface areas of the u-bend GHE that is in the ground is in direct contact with the ground thus optimizing the heat transfer efficiency between u-bend GHE and the ground. Because of our invention the shank spacing between the descending pipe and the ascending pipe is always the same eliminating any thermal short circuiting between the two pipes.

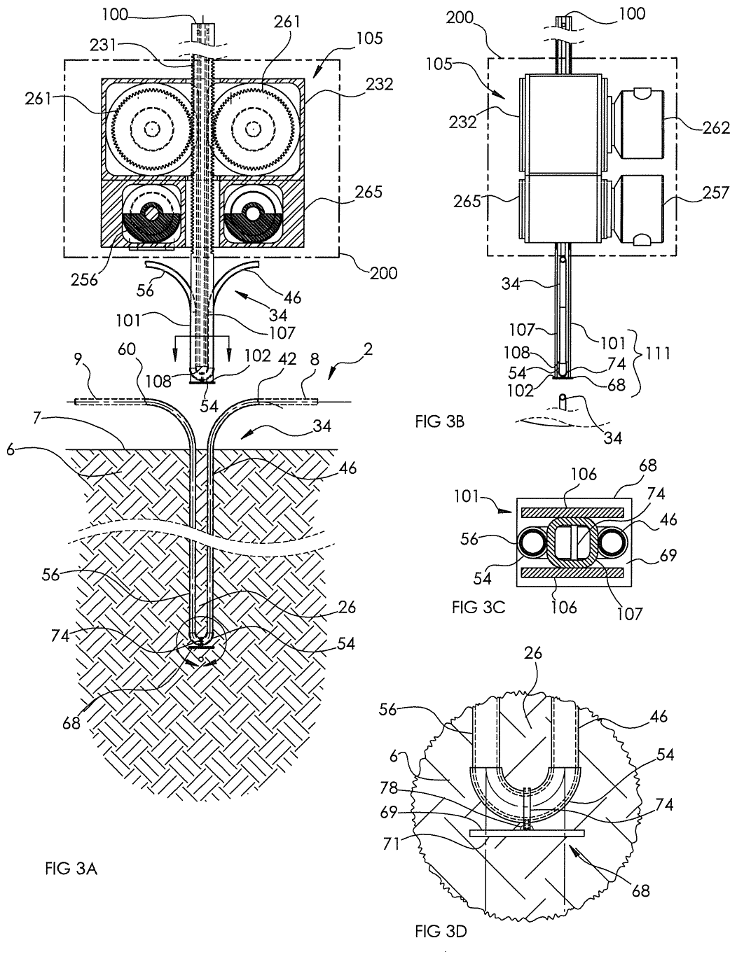

FIG. 3A to FIG. 3D shows a sectioned front elevational view, a side elevational view, a cross sectional plan view and detail view of a u-bend GHE 34 installation 2 installed regardless of the stability of the native soils using the novel installation method with a inserting or extraction tool (CET) 111 and a GHE installer head 200 supporting a insert or extract mechanism (CEM) 105 that is loaded with another u-bend GHE 34 ready to be installed at another location. The GHE installer head 200 would be mounted on some sort of mobile equipment not shown here.

Referring to FIG. 3A and detail FIG. 3D, remaining in the ground 6 with u-bend GHE 34 is the CET 111's anchor 68 and anchor tie 74 with anchor 68's built in anchor tie down 78 used to secure anchor 68 to u-bend GHE 34's u-bend reversing fitting 54. Anchor tie 74 loops through anchor tie down 78 and up and around u-bend reversing fitting 54 and is then permanently locked in a loop form. This anchor 68 with anchor tie 74 holds the u-bend GHE 34 at that ground 6 depth during the installation process which will be elaborated on now.

Referring FIGS. 3A to 3D, the CET 111's mandrel 101 is made up of a mandrel head 100 and mandrel toe 102, a mandrel shank spacer 107 permanently sandwiched between two mandrel plates 106 that have teeth used as a positive drive 231 on opposing edges of the mandrel plates 106. The mandrel 101 is installed into a CEM 105 that is made up of a positive driver 232 fixed to a vibratory hammer 265 and installed into a GHE installer head 200 mounted to mobile equipment not shown. The positive driver 232 has two pinion gears prime movers 261 driven in opposite directions by positive drive motors 262. The vibratory hammer 265 has two adjustable vibratory hammer eccentrics 256 that are linked together by gears not shown so that they turn at the same speed and the orientation of the eccentrics is kept as a mirror image of each other. The vibratory hammer is driven by adjustable speed vibratory hammer motor 257. Mandrel 101 of CET 111 is mounted in the centre of CEM 105 with its positive drive 231 in contact with prime movers 261 of positive driver 232. This arrangement is used to insert the CET 111 loaded with a u-bend GHE 34 into the ground 6. In most cases, excessive ground 6 inserting resistance can be overcome by the combination of inserting using the positive driver 232 and the vibratory hammer 265.

Readying the CET 111 for another u-bend GHE 34 installation, a u-bend GHE 34 is wrapped around mandrel 101 so that descending pipe 46 and ascending pipe 56 are on either side of mandrel shank spacer 107. Mandrel 101 is constructed in a way that mandrel plates 106 are longer than mandrel shank spacer 107 thus creating a space between mandrel toe 102 and mandrel shank spacer toe 108 for u-bend reversing fitting 54 to be located by wrapping around mandrel shank spacer toe 108. Using the anchor tie 74, the anchor 68 is attached to u-bend reversing fitting 54 and is fitted under mandrel 101 so that the anchor top 69 is in contact with the mandrel toe 102.

The mandrel 101, is approximately the same length as the install depth of the u-bend GHE 34 and is used to insert the anchor 68 a set depth into the ground 6 pulling the u-bend GHE 34 with it. As this is happening, the anchor 68 in all but one configuration of the invention protects the u-bend reversing fitting 54 of the u-bend GHE 34 from abrasive damage caused from passing through the ground 6. Mandrel plates 106 guide the trailing GHE descending pipe 46 and ascending pipe 56 into the proper position in the ground 6 with the shank spacing 26 set accurately by mandrel shank spacer 107. A pipe dispensing mechanism PDM is not used in this example, but if it were present the PDM would control the transfer of u-bend GHE 34 pipe to the mandrel 101. The GHE is only inserted to a depth where the GHE pipe inlet/outlet is above the grounds surface 7 for connection to prior art supply header pipe 8 and return header pipe 9 to and from a pump. After the inserting is complete mandrel 101 is extracted from the ground by the CEM 105 with the anchor 68 and anchor tie 74 securely set in the ground 6 holding the u-bend GHE 34 from being extracted along with the mandrel 101 by any friction forces between the two. If a PDM was used and was dispensing fully assembled u-bend GHEs 34 the installation is complete after the mandrel 101 is extracted else the u-bend GHE 34 pipes are cut leaving GHE pipe inlet 42 and GHE pipe outlet 60 with enough excess length to attach to the prior art supply header pipe 8 and return header pipe 9. A u-bend reversing fitting 54 would then be attached to descending pipe 46 and ascending pipe 56 readying the GHE installer head 200 for the next installation.

As the above arrangement is being inserted into the ground 6 the anchor plate pulls the u-bend GHE 34 along with it and the anchor bottom 71 shields the u-bend reversing fitting 54 from the ground's resistant to inserting forces and displaces the ground 6 around the mandrel 101 guiding and carrying the u-bend GHE 34 along with it. Only the sides of the u-bend GHE are subjected to ground 6 pressure and friction during the inserting process. For occasions where coarse aggregates are present and there is a chance of damaging the u-bend GHE 34 sides during inserting, a different mandrel configuration can be used that encloses the u-bend GHE 34 illustrated later. The descending pipe 46 and ascending pipe 56 are kept apart by the mandrel shank spacer 107 during the extraction of mandrel 101 out of the ground 6, eliminating any chance of thermal short circuiting and allows for shank spacings larger than those constrained by prior art bore hole diameters.

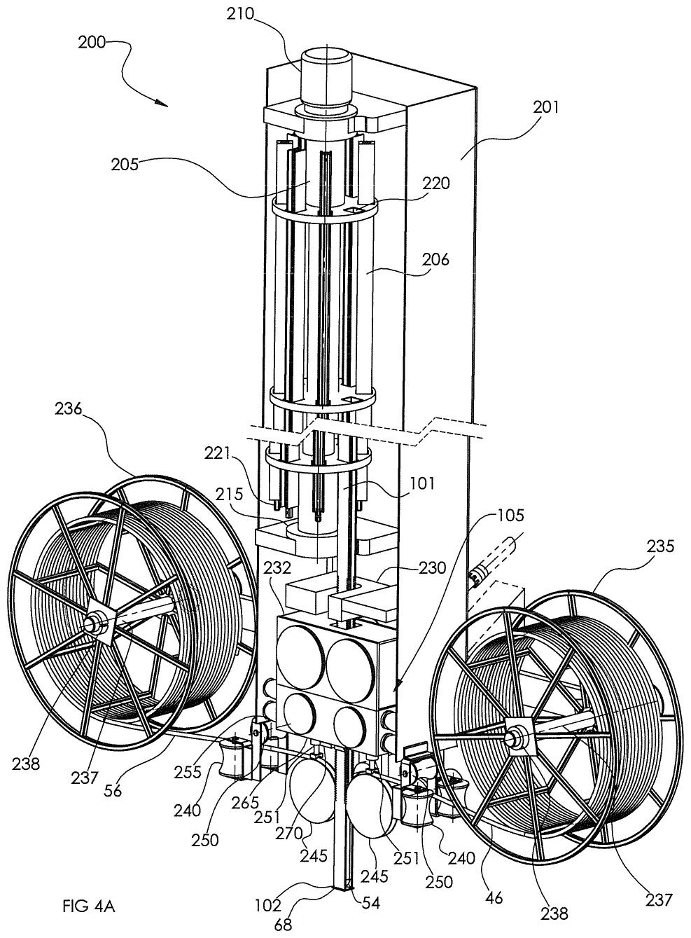

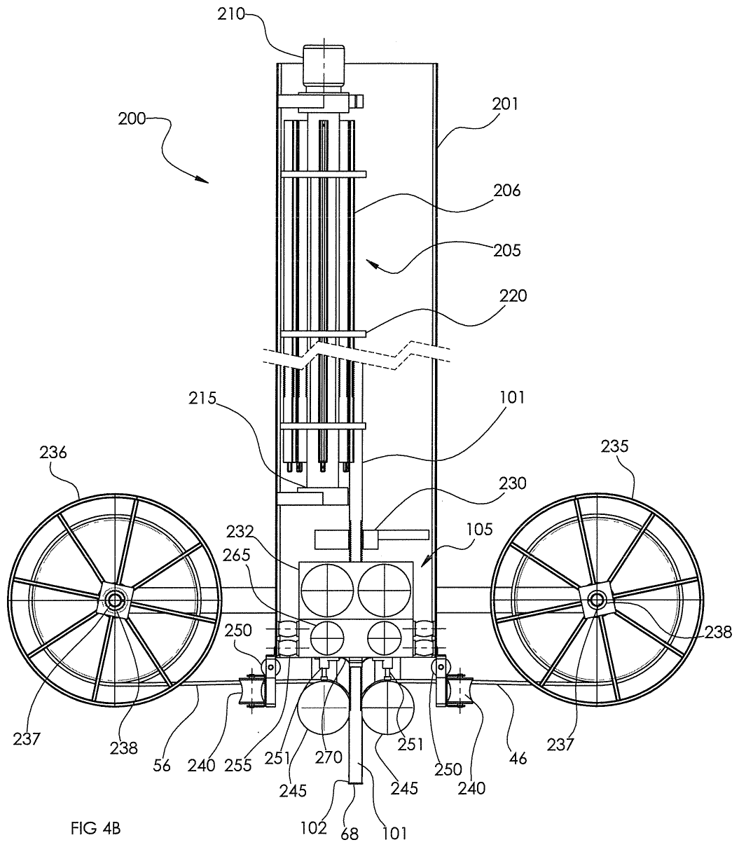

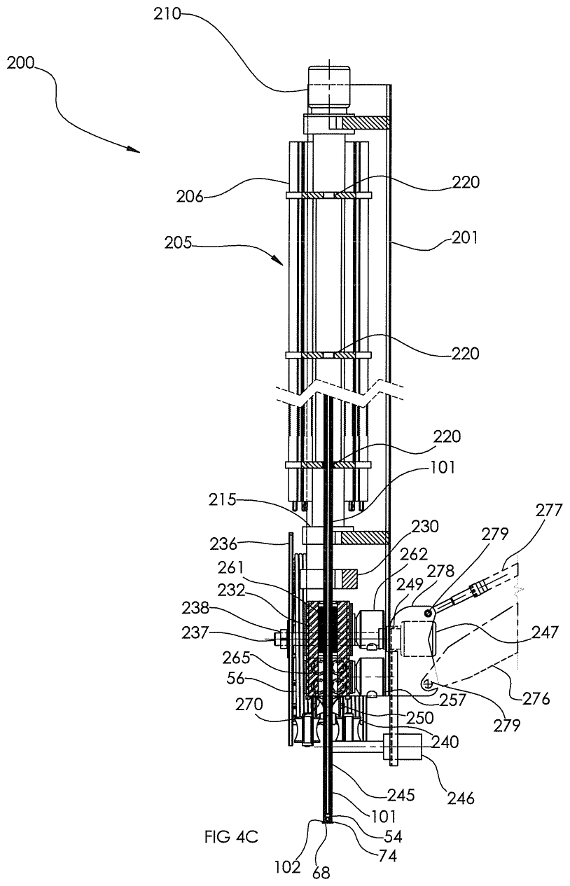

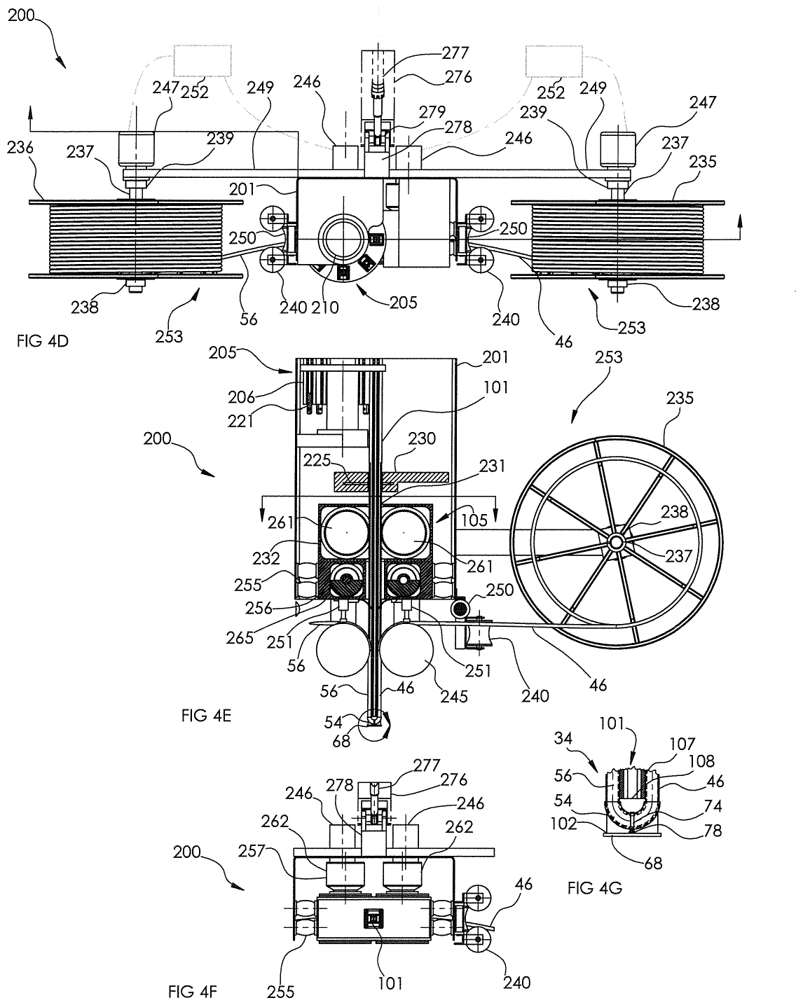

FIGS. 4A to 4G illustrate a perspective view, a front elevational view, a full section elevational view, a plan view, a detail half sectional view, a detail cross sectional view and a detail view of the preferred mechanism for installing GHEs using the novel method described in the summary.

Referring to FIG. 4A, the preferred insert or extract mechanism (CEM) 105 mentioned earlier in FIG. 3A is assembled into a GHE installer head 200 is made up of a hydraulic motor driven mechanical positive driver 232 that inserts or extracts the CET 111 mandrel 101 into and out of the ground having the drive mechanically configured in a way to tolerate extremely dirty environments and be able to slip if encountering more resistant ground layers. The mechanical positive driver 232 can be any mechanical drive capable of inserting or extracting mandrel 101 into and out of the ground and is shown here in its simplest form for illustration purposes. In addition to the mechanical positive driver 232, the CEM 105 has an integrated hydraulic motor driven vibratory hammer 265 to assist with the inserting and extracting function of CET 111 mandrel 101. The vibratory hammer 265 is fixed to the mechanical positive driver 232 which in turn through its positive driver maintains a constant engagement force on mandrel 101 thus allowing vibrations created by vibratory hammer 265 to pass through the mechanical positive driver 232 into mandrel 101 which in turn transfer the harmonic vibrations threw mandrel 101 to the mandrel toe 102, through the anchor 68 to excite the ground particles all around the mandrel 101 and anchor 68 thus allowing easier inserting into the ground. This CEM 105 is mounted to a mast 201 using vibration isolator 255 which isolate a large portion of the vibratory forces from the other equipment on the GHE installer head 200 focusing them on the mandrel 101. Mandrel scrapers 270 are position under the vibratory hammer 265 to minimize the amount of ground that comes into the GHE installer head 200 when mandrel 101 is extracted.

To have a GHE ready for installation, the mandrel 101 is positioned to pass through the middle of the CEM 105 in the GHE installer head 200 as shown and the set up of a pipe dispensing mechanism (PDM) 253 is the same for both descending pipe 46 and ascending pipe 56 described here.

Referring to FIGS. 4D to 4G, working back from the u-bend revering fitting 54, a GHE pipe 46 end is guided to and positioned along side of mandrel 101 by a pipe final guide 245 and wraps around the guide. The guide can be made up by any means that allows the pipe to freely traverse over the guide. The guide is mounted to a common load cell transducer called a brake transducer 246 mounted to the GHE installer head 200. The brake transducer 246 measures the force of the pipe traversing over the final guide 245 and sends an electronic signal to an electronic controller 252 that converts the force into a relative pipe axial tension. A final guide clamp 251 mounted to the bottom of the CEM 105 is used to clamp the GHE pipe to the final guide 245 preventing the pipe from moving when ever the GHE pipe is not being pulled. The pipe is guided to the final guide 245 by one of two other guides, the reel diameter guide 250 and the pipe helix guide 240. These guides can be made up by any means that allows the pipe to freely traverse over them at the same time positioning the pipe. The pipe helix guide 240 guides the pipe coming off the pipe reels 235 and 236 and compensates for any horizontal lateral movement of the pipe caused initially by the pipe being traverse wound onto the pipe reels 235 and 236 or the pipe being loose on the reel. The reel diameter guide 250 guides the pipe coming off the pipe reels 235 and 236 and compensates for any vertical movement of the pipe caused by the change in the pipe wound on the pipe reel's 235 and 236 outer diameter as it is unwound. The pipe reel 235 or 236 is mounted onto a reel shaft 237 and held to it by a reel shaft lock collar 238. The reel shaft 237 is mounted through a free spinning bearing 239 that is mounted to a reel support beam 249 that is mounted on the GHE installer head 200. A reel brake 247 is coupled to the reel shaft 237, fixed to the reel support beam 249. The reel brake 247 is used to restrict the pipe unwind, controlling the rate it turns and rate it supplies pipe to the mandrel 101. The reel brake 247 used can be a friction type brake or can be a motor with both being controlled by an electronic controller 252 with the axial tension feed back input coming from the brake transducer 246 mounted to the pipe's final guide 245. The electronic controller 252, brake transducer 246, and reel brake 247 form a closed loop system that can be set to monitor and control the axial tension placed into the pipe coming off the pipe reels 235 and 236 and being installed into the ground. When ever the GHE pipe is not being pulled the final guide clamp 251 is activated and prevents the GHE pipe from moving thus maintaining the axial tension in the pipe caused by the reel brake 247 and allows the cutting of the pipe after the GHE has been installed. With the axial tension being maintained the pipe wound on the reel cannot open like a clock spring so tapping or strapping of every wound layer of pipe on the reel is not required.

After both the descending pipe 46 and ascending pipe 56 are installed onto mandrel 101 a u-bend reversing fitting 54 is connected and fixed to both pipes connecting them together into a prior art u-bend GHE 34. An anchor 68 is then tied with an anchor tie 74 to the u-bend reversing fitting 54 making the u-bend GHE 34 ready to be installed.

If pipe reels 235 and 236 FIG. 4A have long lengths of pipe for multiple GHE to be cut from, then a u-bend reversing fitting 54 is connected and fixed to descending pipe 46 and ascending pipe 56 for each GHE installation. If the u-bend reversing fitting comes preassembled to descending pipe 46 and ascending pipe 56, then, not shown, the descending pipe 46 and ascending pipe 56 would come off a single reel and helix guide 240, a reel diameter guide 250 and a pipe final guide 245 would be arranged accordingly to facilitate guidance of the pipes onto the side of mandrel 101. An anchor 68 is always attached to u-bend reversing fitting 54 with not shown anchor tie 74 in both circumstances.

Additional splice mandrels 206 are provided to increase the GHE inserting depth capabilities of the machine and are housed in a rotational mandrel storage 205 that can be rotated by mandrel storage motor 210 to position a splice mandrel 206 ready for temporary splicing into the head of the mandrel being driven by the CEM 105 into the ground. The rotational mandrel storage 205 has a mandrel storage lift 215 and a storage guide clamp 220 that assists with the positioning and attachment of the splice mandrel 206 discussed in more detail later. An auto splicer 230 can be an addition to the machine to automatically splice in or out a splice mandrel 206. The storage guide clamp 220 clamps stored splice mandrels 206 to the mandrel storage 205 and guides all mandrels into and out of auto splicer 230 and the CEM 105.

FIG. 4B shows a front elevation of the GHE installer head 200 and is described above.

FIG. 4C shows a sectioned elevation view of the GHE installer head 200 with a mobile mount 278 that allows its attachment to a mobile transport mechanism, via mounting pins 279, adjustable boom 276 and linear actuator 277. Mobile mount 278 is fixed to reel support beam 249 and mast 201.

FIG. 4D shows a plan view of GHE installer head 200 with connection to a mobile transport mechanism. FIG. 4E shows a detail section view of the GHE installer head 200 only showing its lower area and one pipe reel.

Referring to FIG. 4E, auto splicer 230 is fixed to mast 201. Mandrel splice locks 225 stored in auto splicer 230 and are automatically or manually inserted or removed from the mandrel splice when splicing mandrels together.

Referring to FIG. 4E and FIG. 4D, CEM 105 is shown in detail. Mechanical positive driver 232 has within two prime movers 261 that are engaged with mandrel 101's mandrel positive drive 231. The mandrel 101's mandrel positive drive 231 would cover the entire length and at least two sides of all mandrels. The prime movers 261 are driven independently by two hydraulic positive driver motors 262 but could be connected by mechanical chain belt or gears and be driven by one. The mechanical positive driver 232 is fixed to the vibratory hammer 265 forming the CEM 105 which is attached to the mast 210 by vibration isolator 255. Vibratory hammer motor 257 is hidden in FIG. 4F by positive driver motor 262.

FIG. 4G is a detail section elevation of the mandrel toe 102 and illustrates how anchor 68 is attached to prior art u-bend GHE 34. The u-bend reversing fitting 54 is placed in the space between mandrel toe 102 and mandrel shank spacer toe 108 descending pipe 46 and ascending pipe 56 on either side of mandrel shank spacer 107. Anchor 68 is butted up to the mandrel toe 102. Anchor tie 74 loops through anchor tie down 78 and up and around u-bend reversing fitting 54 and is then permanently locked in a loop form securing anchor 68 to u-bend GHE 34. U-bend GHE 34 is held in place by the precise tensile force exerted on the descending pipe 46 and ascending pipe 56 through the pipe reels by the reel brakes 247.

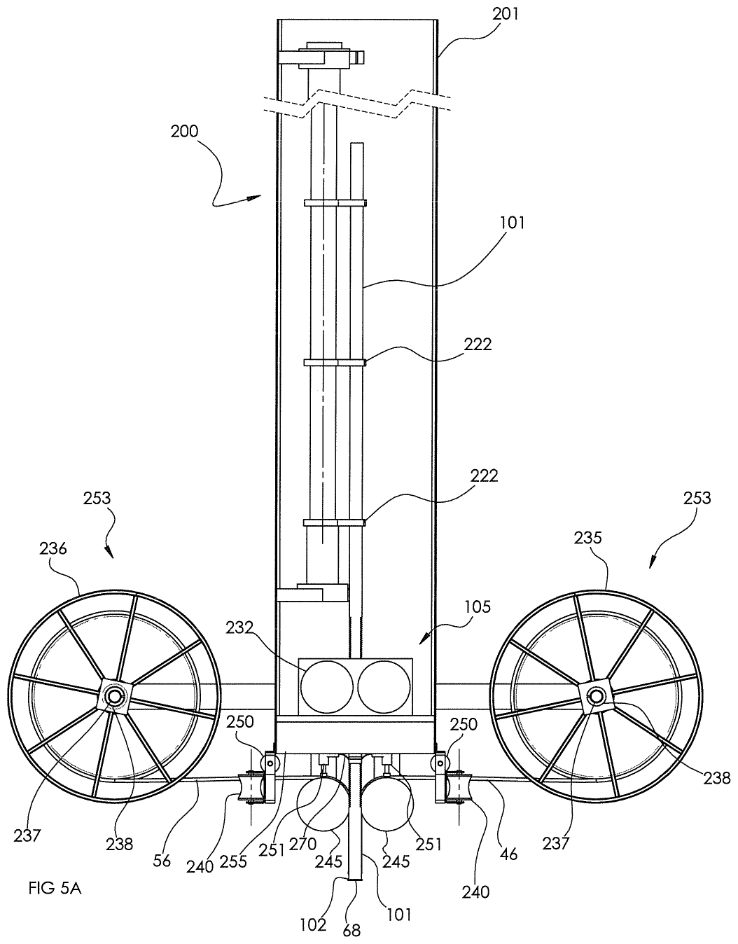

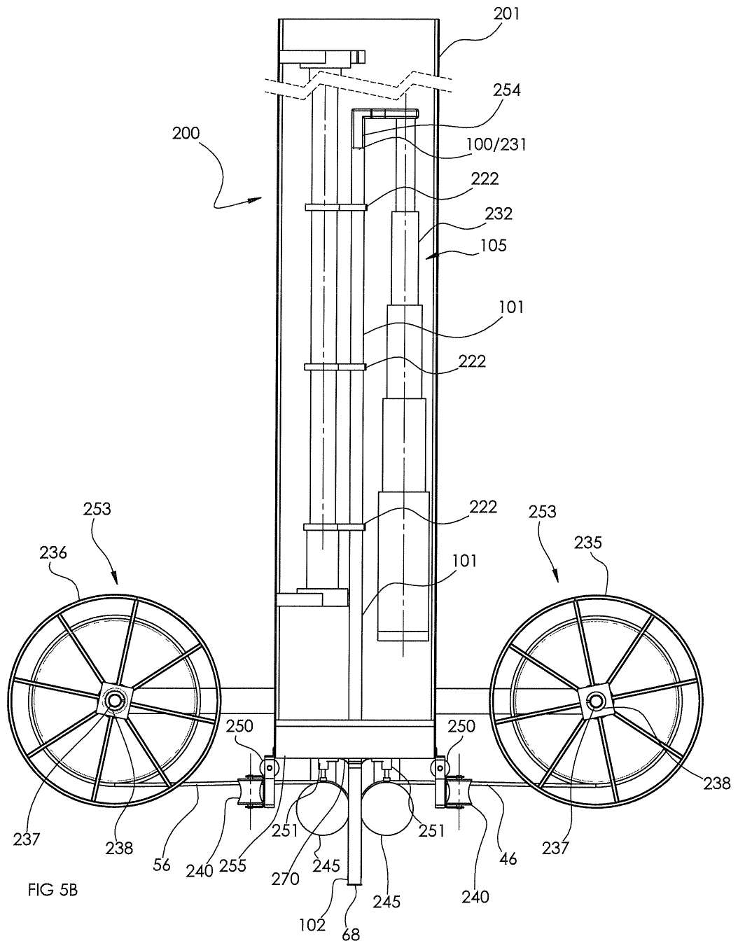

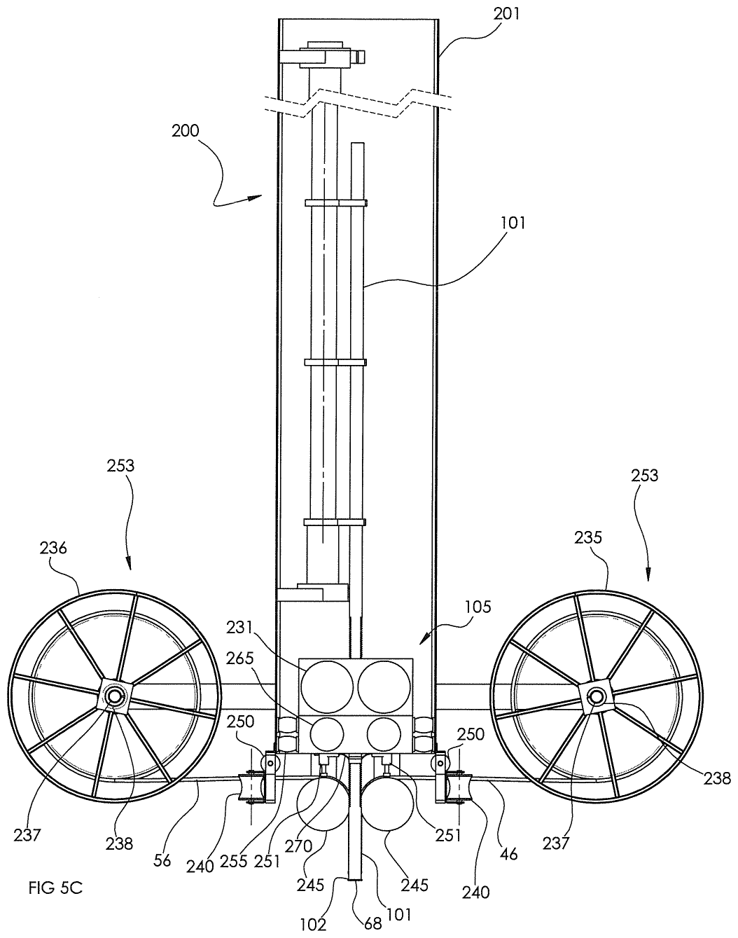

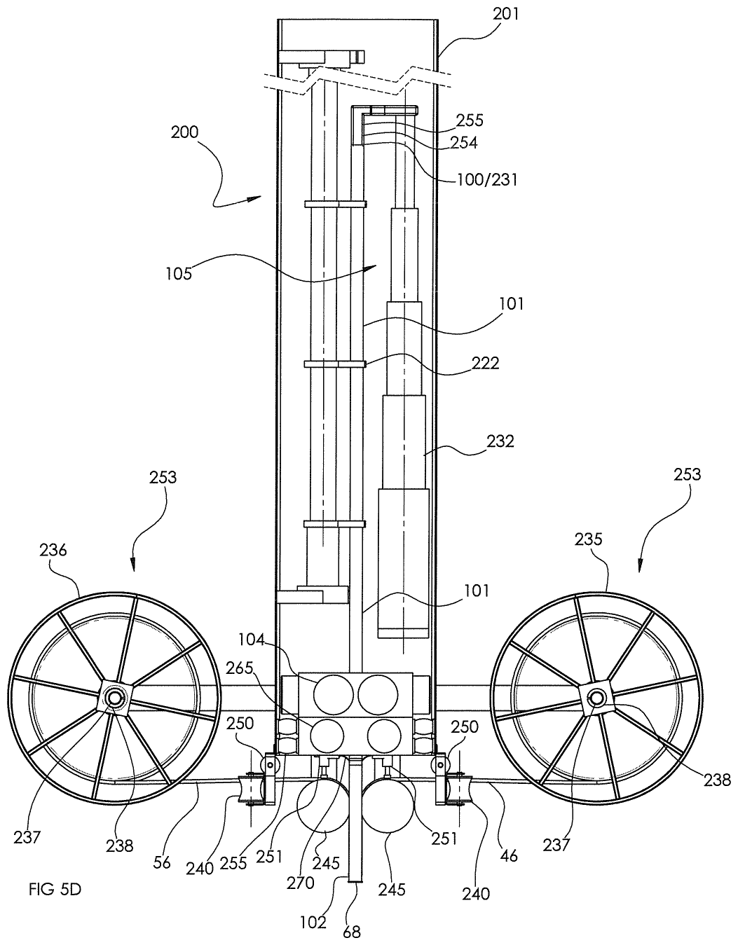

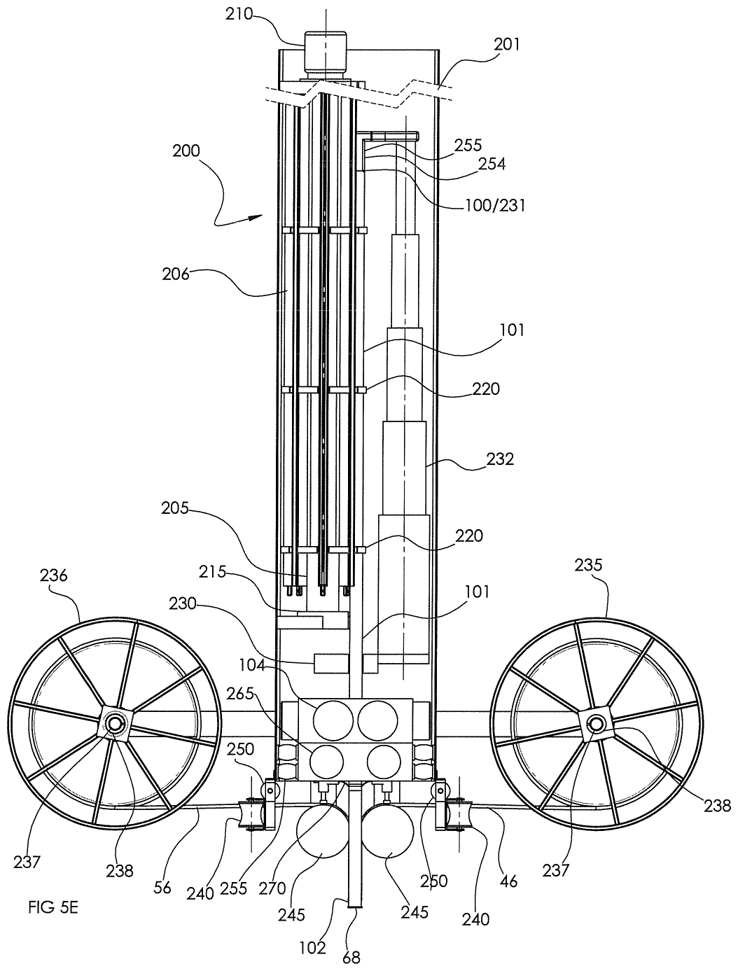

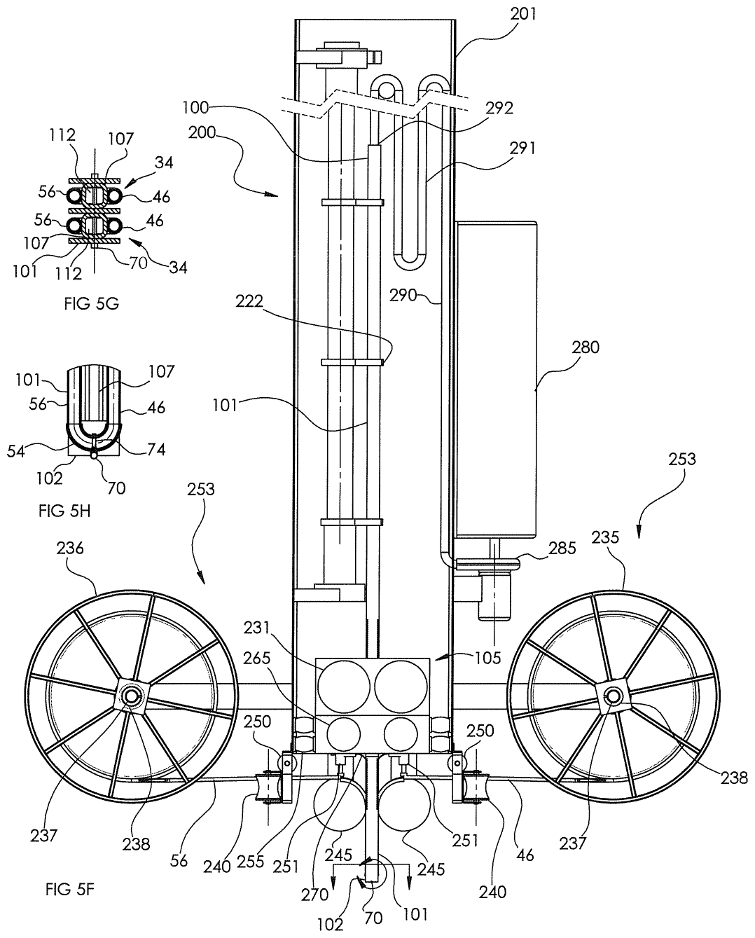

FIG. 5A to FIG. 5F illustrate six elevational views of various other GHE installer head 200 configurations of the above using other types and amounts of mechanical drives and the using of lubrication to assist inserting. FIG. 5G is a detail cross sectional plan view and FIG. 5H is a detail elevational view of FIG. 5F. Only the changed components are discussed below.

FIG. 5A shows a front elevational view of a basic GHE installer head 200 with the CEM 105 being only a mechanical positive driver 232 with out mandrel storage. With this type of configuration mast 201 is usually very tall to accommodate a very long mandrel 101 thus eliminating the need to splice mandrels together to achieve greater inserting depths and minimizing the inserting time. Having no vibratory hammer limits this configuration to ground that is easily penetrate. Mandrel guides 222 are required inside the mast to guide mandrel 101. The workings of the positive driver 232 and PDM 253 remain the same as described with FIG. 4.

FIG. 5B shows a front elevational view of a GHE installer head 200 with the CEM 105's positive driver 232 being a hydraulic cylinder and shown here the mandrel positive drive 231 being the mandrel head 100. As with the configuration in FIG. 5A, with this type of configuration mast 201 is usually very tall to accommodate a very long mandrel 101 thus eliminating the need to splice mandrels together to achieve greater inserting depths and minimizing the inserting time. Having no vibratory hammer limits this configuration to ground that is easily penetrated. A modification to what is shown here to maximize the mandrel length, the hydraulic mandrel drive clamp 254 can be made to hold and release the mandrel along its length thereby allowing a hydraulic cylinder positive driver 232 with a shorter stroke then the mandrel 101 length to be used to insert and extract the mandrel 101. During a typical inserting, the hydraulic cylinder positive driver 232 extends to its maximum length after which the hydraulic mandrel drive clamp 254 clamps onto the mandrel 101 somewhere along its length. The hydraulic cylinder positive driver 232 then retracts inserting the mandrel 101 into the ground till the hydraulic cylinder positive driver 232 has contracted to its minimum length and the mandrel 101 is released from the hydraulic mandrel drive clamp 254. The cycle is repeated till the mandrel is installed to a required depth or when there is no more mandrel to insert. Mandrel 101 extraction is the reverse of the inserting cycle. Mandrel guides 222 are required inside the mast to guide mandrel 101. The workings of the PDM 253 remain the same as described with FIG. 4.

FIG. 5C shows a front elevational view of a GHE installer head 200 with the same CEM 105 as the preferred GHE installer head 200 FIG. 4A but like FIG. 5A and FIG. 5B without the mandrel storage. This would be the preferred configuration for installing many GHEs quickly. The workings of the positive driver 232 and PDM 253 remain the same as described with FIG. 4.

FIG. 5D shows a front elevational view of a GHE installer head 200 with a CEM 105 having a hydraulic cylinder positive driver 232 as shown in FIG. 5B but with the addition of a vibratory hammer 265 along with a mandrel rotary clamp 104 fixed to it to pass the vibrations from the vibratory hammer 265 through tot the mandrel 101. Again, a releasable mandrel drive clamp 254 is required if the mandrel is longer then the stroke of the hydraulic cylinder positive driver 232. A vibration isolator 255 is also required between mandrel drive clamp 254 and the hydraulic drive cylinder to isolate it from most of the vibrations. Mandrel 101 extraction is the reverse of the inserting cycle. Mandrel guides 222 are required inside the mast to guide mandrel 101. The workings of the PDM 253 remain the same as described with FIG. 4.

FIG. 5E shows a front elevational view of GHE installer head 200 configured the same as in FIG. 5D with the addition of mandrel storage 206 and auto splicer 230. With this configuration the hydraulic mandrel drive clamp 254 would always attach to the mandrel head.

FIGS. 5F and 5G shows a front elevational view of a GHE installer head 200 configurations the same as FIG. 5C with the ability to pump a lubricating fluid down a fluid passage 112 in the centre of the shank spacers 107 of mandrel 101 for assisting with the inserting of the CET or to pump grouting fluids to back fill the shank space between both pairs of descending and ascending pipes during the extraction of the mandrel 101. A fluid tank 280 is shown attached to the side of mast 201 but could be located anywhere in the vicinity of installer head 200 or not being a tank at all but a hose from a utility. In this configuration fluid tank 280 feeds pump 285 which pumps lubricating or grouting fluid up pipe 290 into fluid pipe accumulator 291 which makes a fluid mandrel connect 292 to the mandrel head 100 and feeds lubricating or grouting fluid down the fluid passage 112 where it is discharged at the mandrel toe 102. The fluid pipe accumulator 291 accumulates excess pipe to allow mandrel head 100 to progress up and down without overstretching the pipe. FIG. 5G shows a cross sectional view of the mandrel 101 looking towards the mandrel toe 102 and shows a mandrel capable of installing two prior art u-bend GHEs 34 side by side into the ground other hollow mandrels could be used with this set up. The lubricating or grouting fluid passes to the mandrel toe 102 via fluid passage 112. FIG. 5H shows a detail cut away view of the mandrel toe 102 area illustrating the anchor bar used instead of an anchor plate. The anchor bar 70 allows the fluid to pass freely around the anchor lubricating the mandrel toe 102 area during inserting. An anchor plate with fluid passage holes could be used instead of the anchor bar 70. The lubricating fluid pump and motor 285 must produce enough pumping pressure in the lubricating fluid to prevent any ground from back flowing up the fluid passage 112 during inserting of the mandrel 101 into the ground.

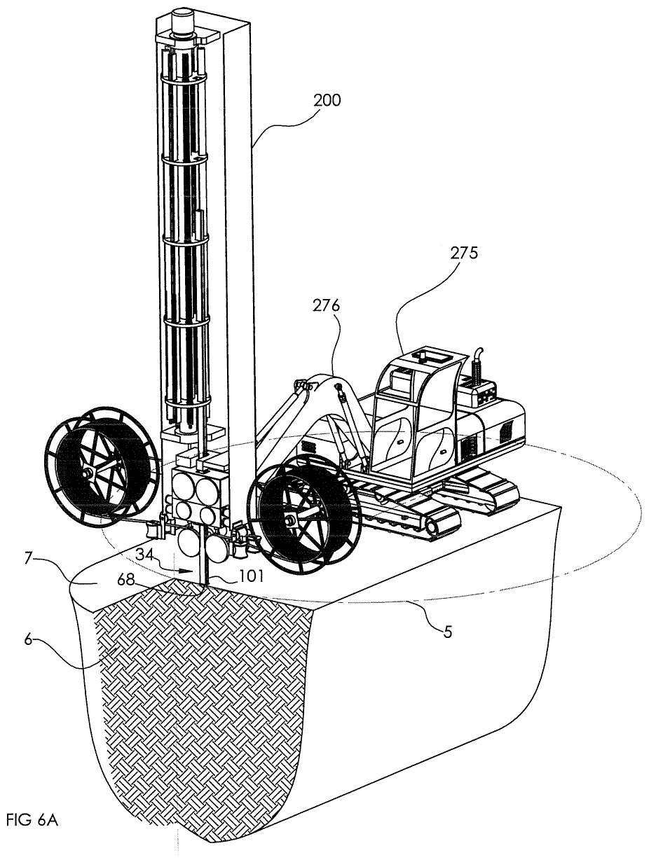

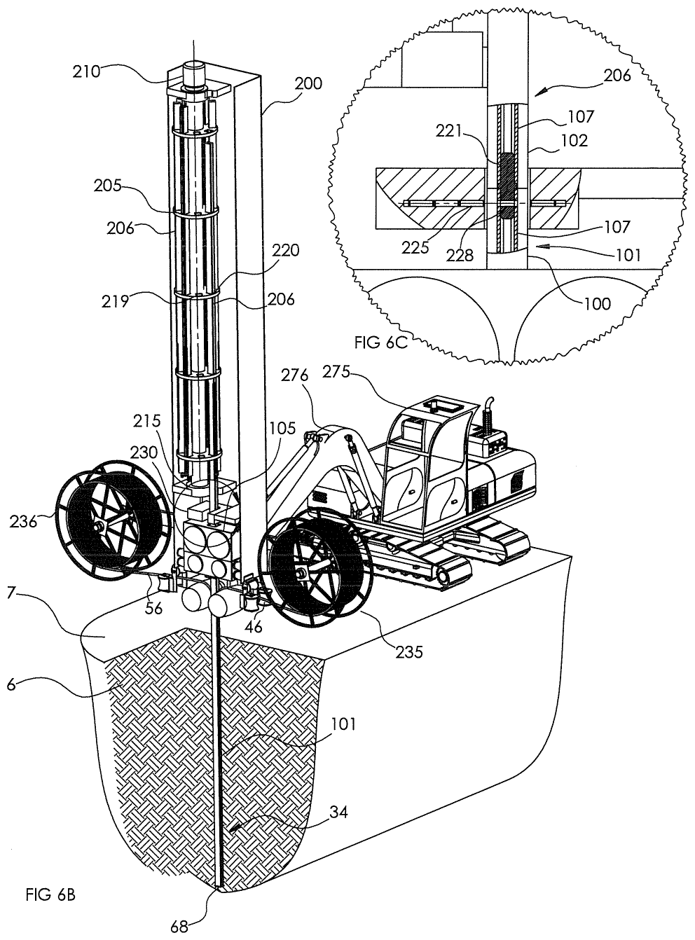

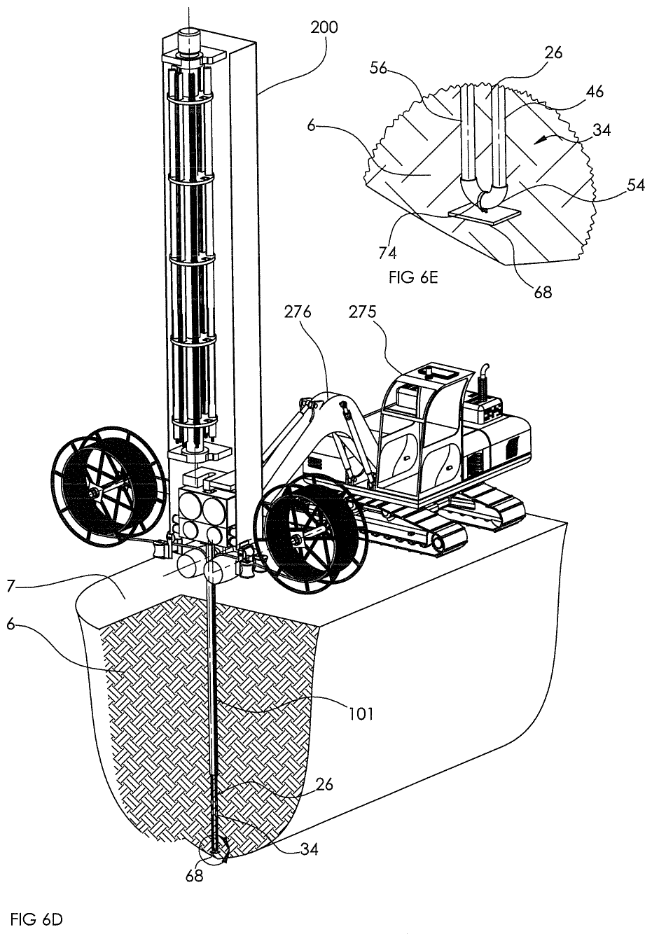

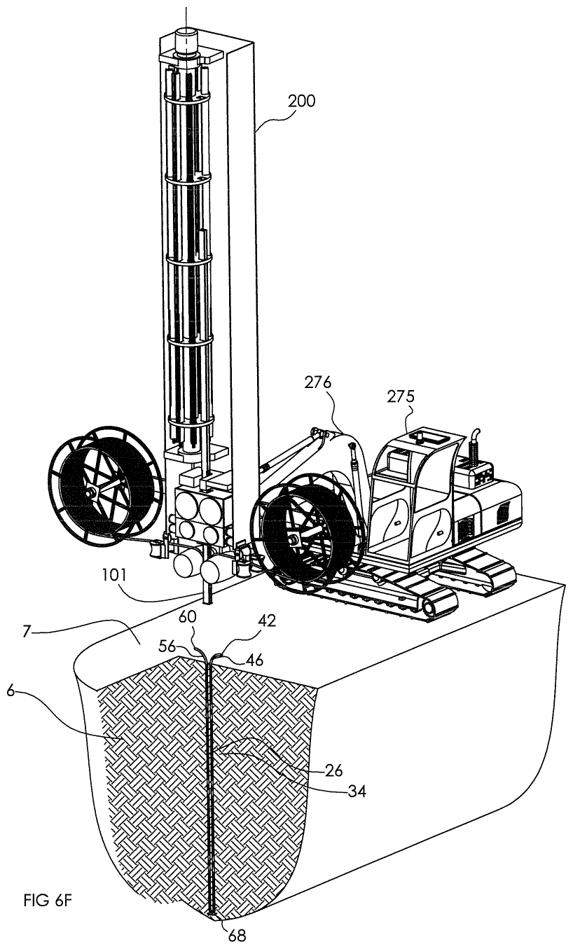

FIGS. 6A to 6F illustrate the GHE installer head 200 mounted to mobile equipment 275 and going through one complete u-bend GHE installation in perspective view with the ground 6 in half section so that one can see what is happening under the ground surface 7.

Referring to FIG. 6A a perspective view of a GHE installer head 200 is mounted to a standard piece of mobile equipment 275 used in the art with adjustable boom 276 which can keep the GHE installer head 200 vertical while at the same time lifting or lowering it as needed. The mobile equipment can also move around on the ground surface 7 to locate the GHE installer head where it is required to install a GHE. The mobile equipment used in the art shown here is also capable of swivelling about its centre axis allowing for multiple GHE installation along a set radius 5. If the mobile equipment had the GHE installer head 200 attached to an adjustable arm which was attached to the adjustable boom 276 then the GHE installer head could be placed in an area on either side of the fixed radius 5 thus allowing even more locations to install a GHE using the GHE installer head. In its simplest configuration, the GHE installer head 200 can be installed directly onto mobile equipment without an adjustable boom 276, arm or swivel. All power be it hydraulic, electric, or pneumatic, needed by the GHE installer head 200 is provided by or carried by the mobile equipment 275. The mobile equipment can be operated from an operator cab if present on the mobile equipment 275 or can be operated remotely using a remote control thus allowing the installation to be done by one or two persons and allowing the mobile equipment size to be minimized for use in areas where maneuverability is limited.

The GHE installer head 200 in this figure is in the ready position to install the prior art u-bend GHE 34 using the mandrel 101. The u-bend GHE 34 is loaded onto the mandrel 101 with an anchor 68 attached as described in detail earlier.

Referring to FIG. 6B, a perspective view of the GHE installer head has inserted the first length of mandrel 101 down into the ground inserting anchor 68 down with it. Because anchor 68 is tied to the prior art u-bend reversing fitting of u-bend GHE 34 and the descending pipe 46 and ascending pipe 56 are connected and fixed to the u-bend reversing fitting, both pipes are pulled down too. At the same time extra descending pipe 46 and ascending pipe 56 is pulled off descending pipe reel 235 and ascending pipe reel 236 respectively passing through various guides, mentioned earlier, that guide the two pipes simultaneously onto mandrel 101. Also as mentioned earlier, the rotation of the reels is controlled to maintain a minimum pull tension on the pipes so that they stay in contact with the mandrel during the entire inserting process.

FIG. 6B also illustrates a perspective view of the GHE installer head 200 splicing in a splice mandrel 206 to inserted mandrel 101. Mandrel 101 has been inserted into the ground far enough for its mandrel head 100 to be inside of the auto splicer 230 creating an empty storage guide clamp 219 on the mandrel storage 205 and prompts mandrel storage motor 210 to rotate mandrel storage 205, with spice mandrel 206 clamped in storage guide clamp 220 so that splice mandrel 206 is positioned inline directly over mandrel 101. Referring to FIGS. 6B and 6C a detail sectional view of the auto splicer 203 and the mandrel head 100 of mandrel 101 and the mandrel toe 102 of the splice mandrel 206, the mandrel toe 102 of splice mandrel 206 comes with the top end of a mandrel splice post 221 permanently fixed into a hollow in its mandrel shank spacer 107, and the bottom end of the mandrel splice post 221 fit inside a hollow in the mandrel shank spacer 107 at the mandrel head 100 of mandrel 101. Mandrel storage lift 215 lowers mandrel storage 205 so that the toe of mandrel 206 meets the head of mandrel 101 at the same time setting the bottom end of the mandrel splice post 221 into a hollow in mandrel 101's mandrel shank spacer 107 before releasing the clamping force of storage guide clamp 220 turning it into a guide, then mandrel storage lift 215 lifts mandrel storage 205. The bottom end of mandrel splice post 221 has a splice lock hole 228 that lines up with holes in the mandrel head 100 of mandrel 101. The auto splicer inserts a temporary but secure mandrel clamping splice lock 225 into splice lock hole 228 locking the holes in the mandrel head 100 of mandrel 101 to the splice lock hole 228 and thus spicing splice mandrel 206 to mandrel 101 forming a combined elongated mandrel. The mandrel clamping splice lock 225 ensures that any vibrations from the CEM 105 in the GHE installer head 200 are transferred through the splice and into mandrel 101 once it is below the CEM 105. These steps are repeated for every splice mandrel 206 added to the combined elongated mandrel. The above steps are reversed when breaking a combined elongated mandrel during mandrel extraction.

FIG. 6D shows a perspective view of the GHE installer head 200 in the process of extracting the mandrel 101 from the ground 6 with anchor 68 holding prior art u-bend GHE 34 back and in place while its pipe slips from mandrel 101 with shank spacing 26 being maintained. FIG. 6E shows u-bend GHE's 34 reversing fitting 54 with descending pipe 46 and ascending pipe 56 attached and held in place with anchor tie 74 attached to anchor 68 while maintaining shank spacing 26. The shape and size of the anchor can and will be adjusted to suit different ground conditions.

FIG. 6F illustrates perspective view of a completed installation of a prior art u-bend GHE 34 using a GHE installer head 200. The mandrel 101 is shown extracted and the adjustable boom 276 of the mobile equipment 275 has been lifted slightly showing the top of the prior art u-bend GHE 34, its descending pipe 46 and GHE pipe inlet 42 and the ascending pipe 56 and its GHE pipe outlet 60. Anchor 68 at the bottom of u-bend GHE 34 is no longer needed because the ground pressure has placed the ground displaced by the mandrel 101 back and against the u-bend GHE 34 and at the same time maintaining the shank spacing 26 over the entire length of u-bend GHE 34. The u-bend GHE's 34 shank 26 spacing coupled with its direct contact with the ground optimizes its heat transfer capabilities.

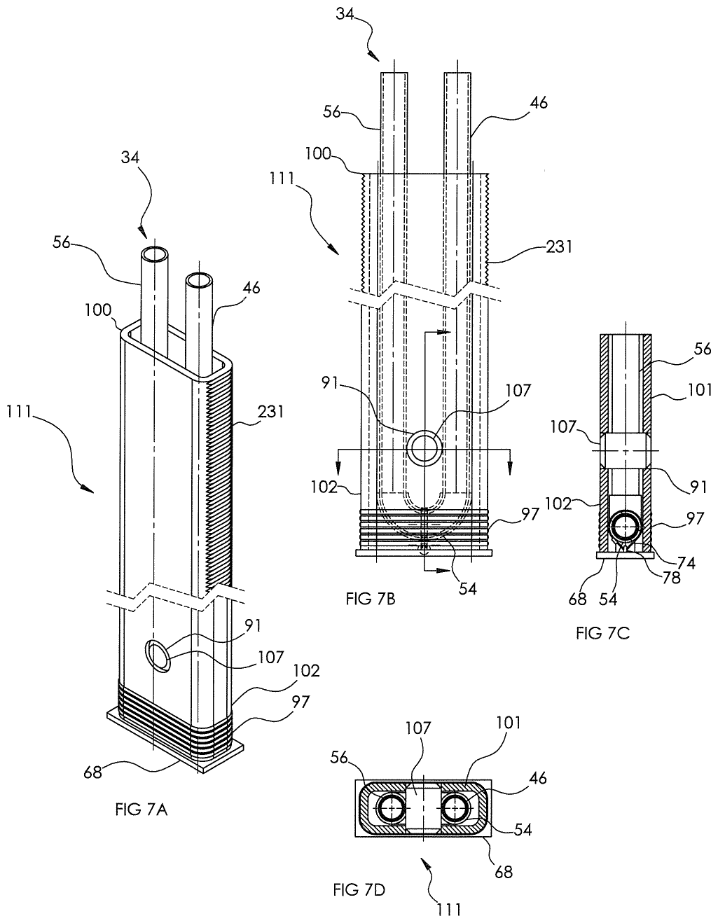

FIGS. 7 to 15 illustrate just some of the various inserting or extraction tool (CET) 111 configurations that can be made with various materials with a preference for steel or other high strength metals and used to install various GHEs types including ones not shown. All the mandrels 101 used to install prior art u-bend GHE 34 have a mandrel shank spacer 107. Note that all CET 111 arrangements must have of some shape or form an elongated mandrel 101 and an anchor 68 with tie down 78, and an anchor tie 74 to tie the anchor to a GHE. All figures FIGS. 7 to 15 a prior art GHE is shown with a way of fastening an anchor to it.

FIGS. 7A to 7D show a perspective view, a front elevational view, a half section elevational view and a cross sectional plan view of a CET 111's mandrel 101 made from preferably a hollow rectangular steel tube with a prior art u-bend GHE 34 loaded inside and fastened to anchor 68 with anchor tie down 78 which is used to secure anchor 68 to u-bend reversing fitting 54 using anchor tie 74. Anchor tie 74 loops through anchor tie down 78 and up and around u-bend reversing fitting 54 and is then permanently locked in a loop form. A mandrel spacer 107 is permanently fixed in mandrel shank spacer hole 91 across the mandrel just above u-bend reversing fitting 54 bisecting descending pipe 46 and ascending pipe 56 so that after mandrel 101 is inserted into the ground and anchor plate 69 is set, as the mandrel is extracted the descending pipe 46 and ascending pipe 56 flow out of hollow mandrel 101 around mandrel spacer 107 creating shank spacing between the two pipes. This Mandrel 101 is shown with mandrel positive drive 231 to allow for a positive driver to insert and extract the mandrel into and out off the ground, but other means of positive drive can be used. Mandrel wear resistant coating 97 used in the art made of wear resistant material preferable tungsten carbide is located around the mandrel toe 102 to extend the life of mandrel 101. Hollow tube or pipe mandrels 101 are loaded from the top or bottom opening in the mandrel 101. If loading from the top, and mandrel shank spacer 107 is fixed, only an unassembled u-bend GHE 34 can be loaded into the top of the mandrel 101 with a descending pipe 46 and an ascending pipe 56 fed down the mandrel on either side of the mandrel shank spacer 107 prior to being connected and fixed to a u-bend reversing fitting. The top loading allows for a continuous length of both pipes to be fed with a new reversing u-bend fitting 54 being connected and fixed each time after a u-bend GHE 34 has been installed and the continuous pipes cut. If loading from the top, and mandrel shank spacer 107 is removable between each u-bend GHE 34 installation the assembled u-bend GHE 34s can be fed into the top of hollow mandrel 101. When feeding hollow type mandrels 101 from the bottom a cable/rope needs to be fed down from the mandrel head 100 for each pipe and fed around mandrel shank spacer 107 and attached, one to each descending pipe 46 and ascending pipe 56 and drawn up the inside of the hollow mandrel 101 to a set distance before a reversing u-bend fitting 54 is connected and fixed to the pipes forming a u-bend GHE 34. This same method can be used if the u-bend GHE 34 come to the site already assembled to a u-bend reversing fitting which is common practice. Of course, a winch and pulley system used in the art would be incorporated to handle the cable/rope manipulation for efficiency.

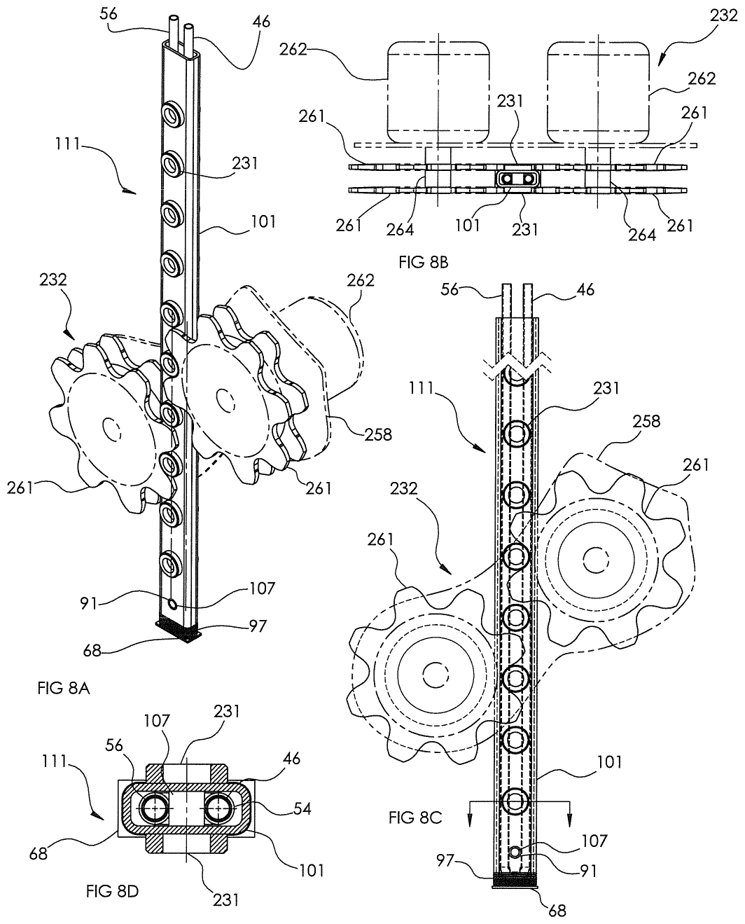

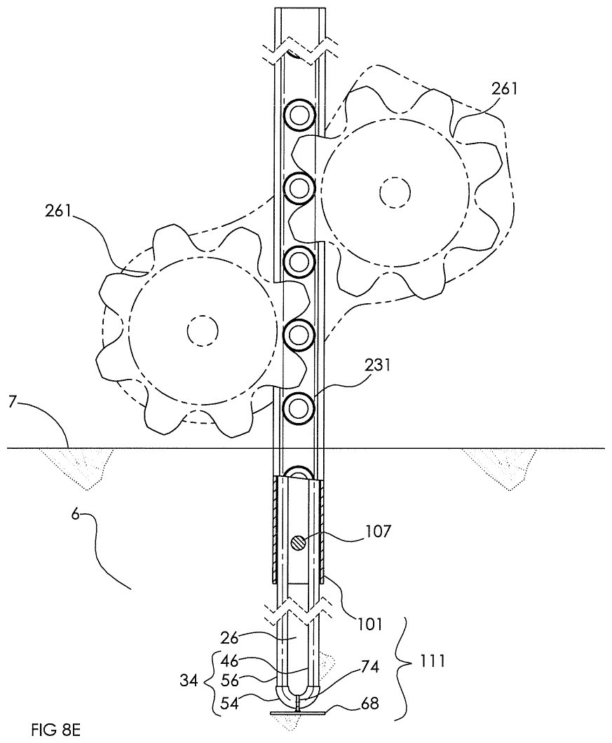

FIGS. 8A to 8D show a perspective view, a plan view, an elevational view and a cross sectional plan view of a CET 111's mandrel 101 with a prior art u-bend GHE 34 loaded inside and fastened to anchor 68 as described in detail earlier. The hollow rectangular mandrel 101 has mandrel spacer 107 permanently fixed into mandrel shank spacer hole 91 to guarantee the shank spacing between descending pipe 46 and ascending pipe 56 during u-bend GHE 34 installation.

The mandrel 101 is fitted with a prior art hardened steel mandrel positive drive 231 to ensure a positive inserting or extraction of the mandrel into and out of the ground and is shown being driven by a prior art sprocket type mechanical positive driver 232 driving mechanism in phantom lines. As common in the art, the mandrel positive drive 231 are placed symmetrically on either side of mandrel 101 and are driven by 4 prime movers 261, two per motor shaft 264 placed on either side of mandrel 101 and driven by two positive driver motors 262. The positive driver motors 262 are mounted to a positive driver motor mount 258 that is part of a mechanical positive driver 232 which is part of a GHE installer head mounted onto some type of mobile equipment. This prior art arrangement with the large mandrel positive drive 231 and prime movers 261 allows for any ground that returns with the mandrel as its being extracted to be easily dislodged, will not jam up the drive and centres the driving force in the centre of the mandrel and therefore is the preferred driving method for GHE installer heads.

FIG. 8E shows a front section elevational view with cut out of this arrangement in use extracting the CET 111's mandrel 101 from the ground 6 and leaving the prior art u-bend GHE 34 installed with the anchor 68 fastened to the u-bend reversing fitting 54 as described earlier. The mandrel 101 is extracted from the ground via the positive upward driving force of the prime movers 261 on the mandrel positive drive 231. The shank setting pin keeps the descending pipe 46 and the ascending pipe 56 apart during the extraction of mandrel 101 thus creating a constant shank spacing 26.

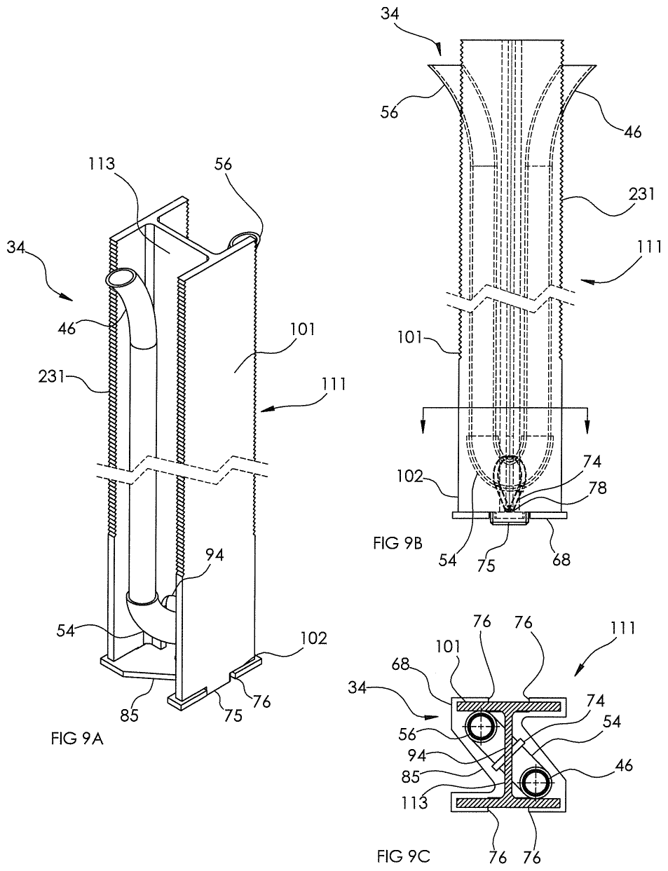

FIGS. 9A to 9C show a perspective view, a front elevational view and a cross sectional plan view of a CET 111 with its mandrel 101 made from a prior art structural steel H-section loaded with a prior art u-bend GHE 34. Descending pipe 46 and ascending pipe 56 of u-bend GHE 34 straddles the H-section's web 113 along its length and fastens to anchor 68 with anchor tie down 78 which is used to secure anchor 68 to u-bend reversing fitting 54 using anchor tie 74. Anchor tie 74 loops through anchor tie down 78 and up and around u-bend reversing fitting 54 and is then permanently locked in a loop form. A mandrel cut out 94 is made in H-section web 113 of the mandrel toe 102 to allow u-bend reversing fitting 54 to pass through to either side. Anchor alignment notches 76 align anchor 68 with mandrel alignment tabs 75 so the anchor 68 does not rely entirely on anchor tie 74 to prevent it from moving laterally during inserting into the ground. This mandrel 101 is shown with mandrel positive drive 231 to allow for a positive drive to insert and extract the mandrel into and out off the ground, but other means of positive drive can be used. Used during the inserting of the entire assembly shown, an anchor cut out 85 is made in anchor 68 to minimize the surface area of anchor 68 thus minimizing the mandrel inserting force required while leaving enough anchor plate to protect the u-bend reversing fitting 54 and to allow the ground to fill into the area where the u-bend GHE 34 is. This ground filling will maintain a constant shank space between descending pipe 46 and ascending pipe 56. Descending pipe 46 and ascending pipe 56 are held straight and in place during inserting due to tension on the pipe imposed by a pipe dispensing mechanism PDM in the GHE installer head not shown here.

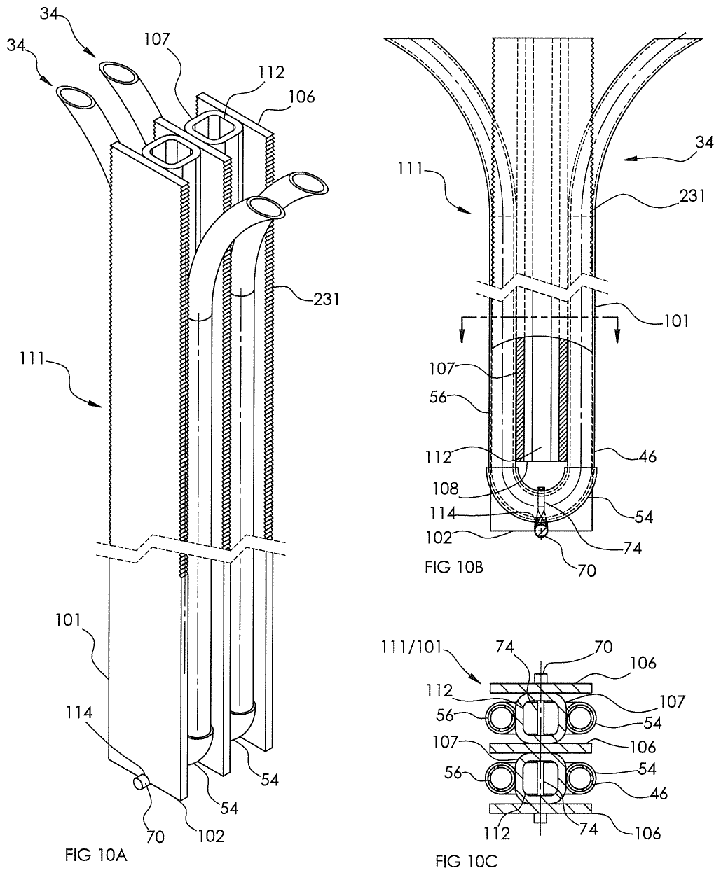

FIGS. 10 A to 10C shows a perspective view, a partially sectioned front elevation view and a cross sectional plan view of a built-up CET 111 mandrel 101 made of two hollow mandrel shank spacers 107 sandwiched between 3 mandrel plates 106. A prior art u-bend GHE 34 is loaded by wrapping around mandrel 101 so that two descending pipes 46 and two ascending pipes 56 are on either side of two mandrel shank spacers 107 with both pairs of pipes connected to their own u-bend reversing fittings 54. Mandrel 101 is constructed in a way that mandrel plates 106 are longer than mandrel shank spacers 107 thus creating a space between mandrel toe 102 and mandrel shank spacer toe 108 for u-bend reversing fitting 54 to be located by wrapping around mandrel shank spacer toe 108. The anchor bar 70 is located into mandrel anchor bar notches 114 cut into all three mandrel plates 106 and fixed in place using anchor tie 74 connecting the u-bend reversing fitting 54 and anchor bar 70 together. The hollow mandrel shank spacers 107 can be used as fluid passages 112 to carry inserting lubricants or cutting fluids for assisting with the inserting of the assembly or for grouting fluids to back fill the shank space between both pairs of descending and ascending pipes during the extraction of the mandrel 101. In the former application the anchor bar 70 is of such a size and configuration to allow fluid to pass by it. If an anchor plate is needed instead of anchor bar, holes can be supplied in the anchor plate for the passage of fluid during inserting. With both the anchor bar 70 and an anchor plate with holes the fluid pressure must be higher than the ground pressure to prevent ground from filling the fluid passages 112 in mandrel shank spacers 107.

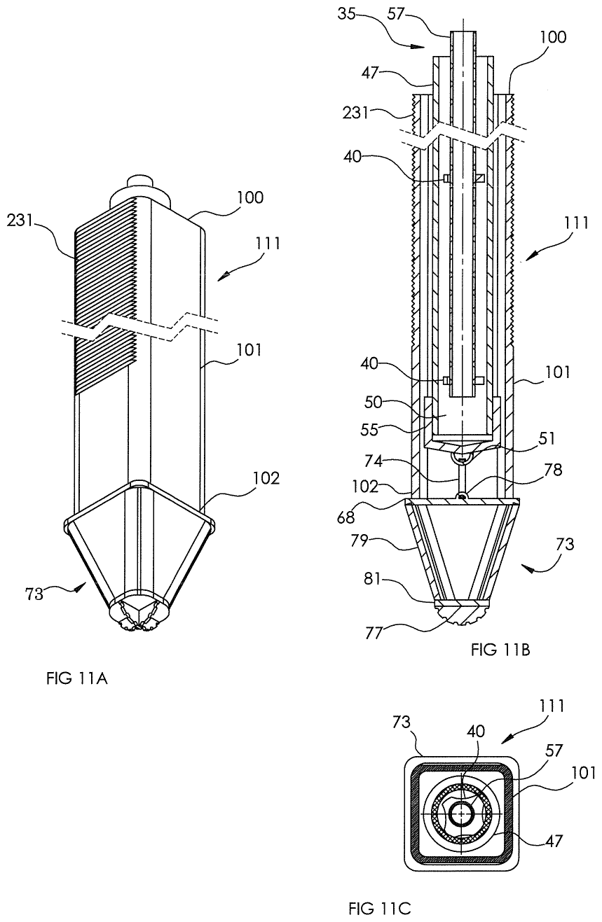

FIGS. 11A to 11C shows a perspective view, a full sectioned front elevational view and a cross sectional plan view of a CET 111 mandrel 101 made from a hollow square steel tube with a concentric GHE 35 loaded for installing. The prior art concentric GHE 35 consists of an outer descending pipe 47 mating with an end cap 55 that has a built in concentric GHE tie down 51, an inner ascending pipe 57 mounted and centered with concentric pipe spacers 40 inside of the outer descending pipe 47 and located so a concentric reversing space 50 is formed. The partially assembled concentric GHE 35 is loaded inside mandrel 101 and fastened to pyramidal anchor 73 with anchor tie down 78 which is used to secure pyramidal anchor 73 to end cap 55 using anchor tie 74. Anchor tie 74 loops through anchor tie down 78 and concentric GHE tie down 51 and is then permanently locked in a loop form. This illustration shows the concentric GHE 35 with concentric pipe spacers 40 that are not always used in practice. This Mandrel 101 is shown with mandrel positive drive 231 to allow for a positive drive to insert and extract the mandrel into and out of the ground, but other means of positive drive can be used. The pyramidal anchor 73 consists of anchor 68, pyramidal section 79, pyramidal tip 81 and rock breaker 77 all fixed together to act as one. The pyramidal shape minimizes the compacting of the ground by the pyramidal anchor 73 as it is inserted into the ground by the mandrel 101, displacing the ground to the sides thus reducing the inserting force required. The rock breaker 77 is used to break small rocks and small boulders when the GHE installer head comes equipped with a vibratory hammer and is usually made from a hardened alloy steel.

Hollow mandrels 101 are loaded from the mandrel head 100 or mandrel toe 102 opening in the mandrel 101. If loaded from the mandrel head 100, an outer descending pipe 47 with or without end cap 55 and/or inner ascending pipe 57 can be lowered from mandrel head 100 down inside mandrel 101 till it reaches the mandrel toe 102 where the inner ascending pipe and/or an end cap 55 can be assembled if required. In all cases an end cap with some form of concentric GHE tie down 51 must be assembled to the outer descending pipe so that an anchor can be added. The top loading allows for a continuous length pipe to be fed with a new end cap 55 being assembled each time after a concentric GHE has been installed and the continuous pipe cut. The inner ascending pipe 57 can be added after installation of the outer descending pipe. When feeding hollow mandrels 101 from the mandrel toe 102 a cable or rope needs to be fed down from the mandrel head 100 and attached to at least the outer descending pipe 47 and drawn up the inside of the hollow mandrel 101 to a set distance before an end cap 55 is connected and fixed to the pipe. Of course, a winch and pulley system communing used in the art would be incorporated to handle the cable/rope manipulation for efficiency. Both methods can be used if the concentric GHE comes to the installation site preassembled as shown.

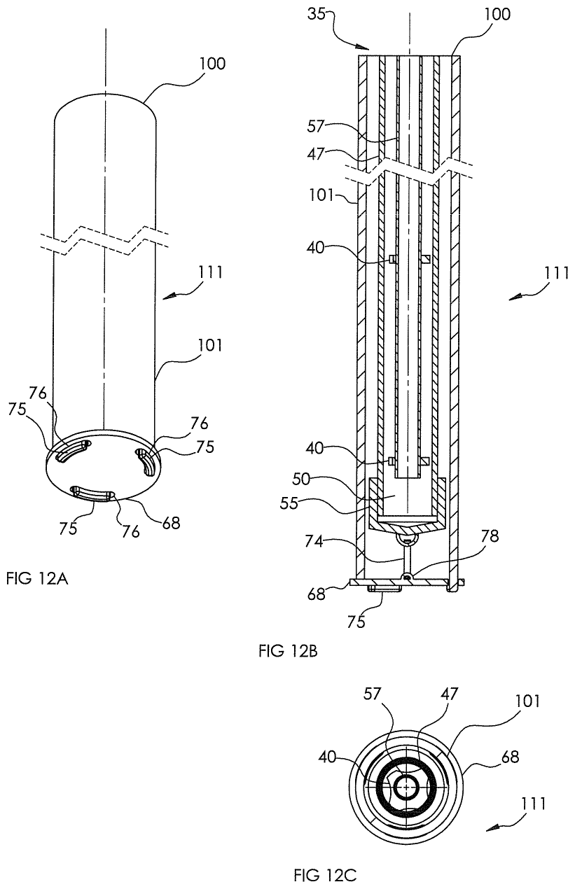

FIGS. 12A TO 12C illustrate a perspective view, a front full sectional elevational view and a cross sectional plan view of a CET 111's mandrel 101 that is set up to install a prior art concentric GHE 35 the same way as in FIG. 11 but the hollow mandrel 101 is round with alignment tabs 75 as apposed to square with no alignment tabs. Also, anchor 68 comes with anchor alignment notches 76 to mate with alignment tabs 75 and does not have a pyramidal shape with rock breaker.

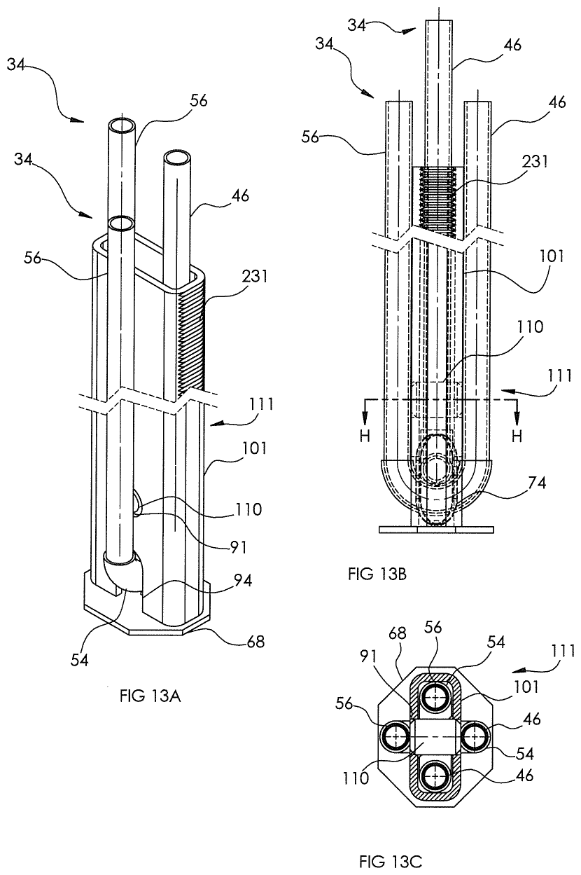

FIGS. 13A to 13C illustrate a perspective view, a front full elevational view and a cross sectional plan view of a CET 111's mandrel 101 that is loaded to install two prior art u-bend GHE 34 one on the inside and one on the outside of a hollow rectangular structural steel tube mandrel 101. The mandrel 101 is set up and functions the same way as already discussed in FIG. 7 for one of the inside u-bend GHE 34. The outside GHE 34 has a mandrel cut out 94 to allow its u-bend reversing fitting to pass through the mandrel 101 and under the u-bend GHE inside the tube like the cut out 94 in FIG. 9.

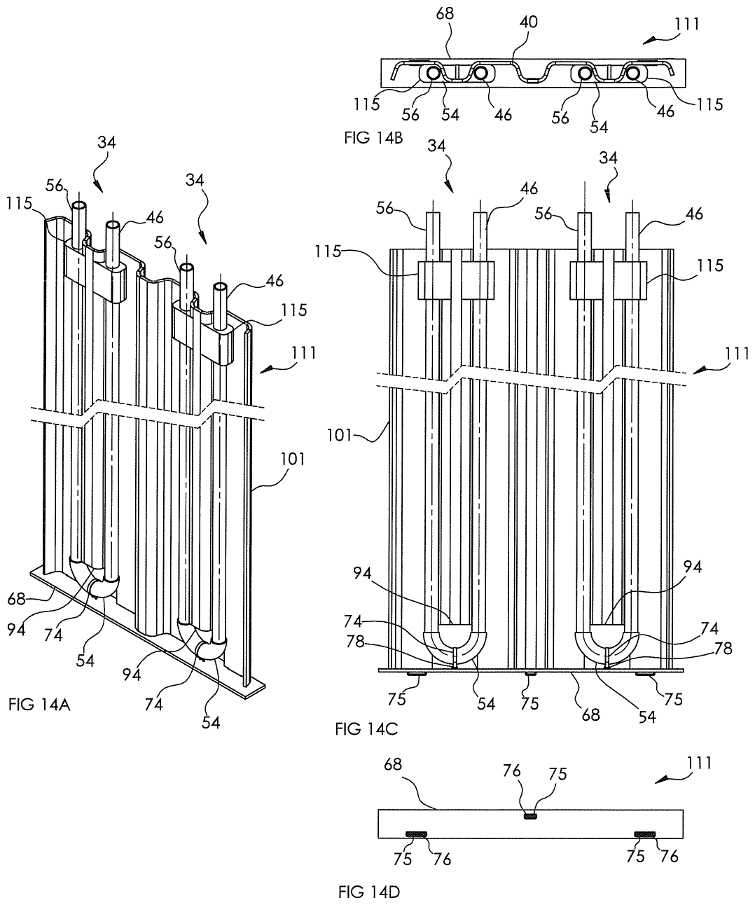

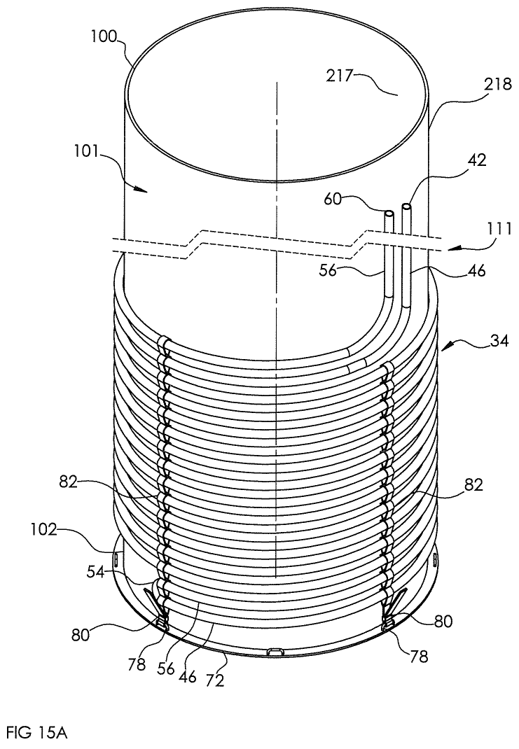

FIGS. 14A to 14D show a perspective view, a top plan view, a front elevational view, and a bottom plan view of a CET 111 mandrel 101 made from a corrugated metal plate that has two prior art u-bend GHEs 34 loaded for installation. The mandrel 101 has two mandrels cut outs 94 that allow the two u-bend reversing fittings 54 to fit within placing each descending pipe 46 and ascending pipe 56 close to the surface of mandrel 101. An anchor 68 has 3 anchor alignment notches 76 and two anchor tie downs 78 to allow both u-bend GHEs 34 to be tied down using two anchor ties 74. Mandrel 101 has three mandrel alignment tabs 75 that fit into the 3 anchor alignment notches 76 keeping the anchor from moving laterally during inserting of the assembly into the ground. Un-like with the H-section mandrel shown in FIG. 9, the descending pipes 46 and ascending pipes 56 are held straight and in place during installation due to tension on the pipe imposed by pre-tensioning the pipes prior to installation and using mandrel tension retaining clamps 115 to clamping them to mandrel 101. Once inserted the mandrel tension retaining clamps 115 are released so that the mandrel 101 can be extracted leaving the u-bend GHEs 34 in place. The mandrel tension retaining clamps 115 can also be used to extract the mandrel 101 with the GHE in the event the required depth is not reached for what ever reason thus eliminating the need to grout fill a failed GHE installation.

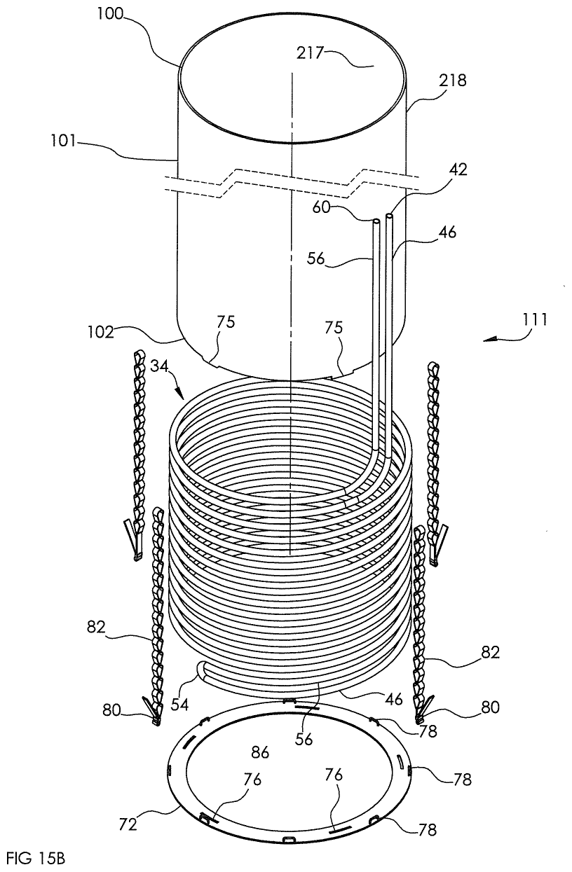

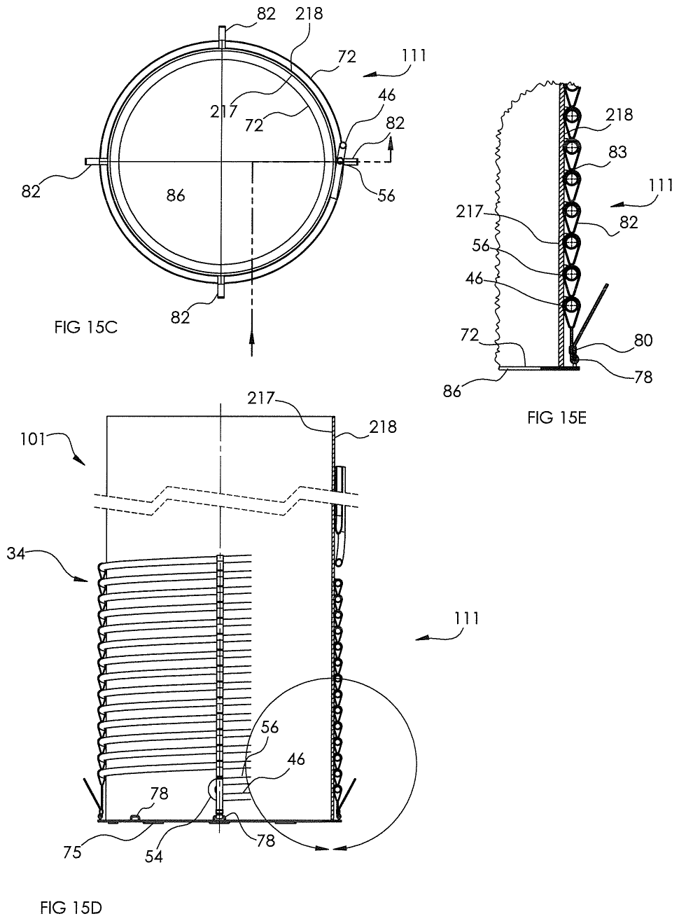

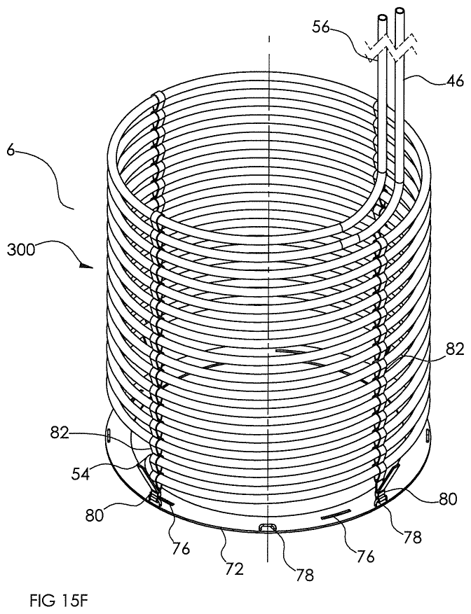

FIGS. 15A to 15e show a perspective view, an exploded perspective, a half section elevational view, a plan view and a detail partial section view of a CET 111 with a large hollow cylinder mandrel 101 having a mandrel head 100, a mandrel toe 102, a mandrel inside 217, a mandrel outside 218 and a mandrel alignment tab 75, aligned and in contact with an anchor ring 72 with a ring anchor open area 86, anchor tie downs 78 and anchor alignment notches 76. The mandrel 101 is loaded in a with a prior art u-bend GHE 34 loosely wound around the mandrel outside 218 starting at the mandrel toe 102 progressing clockwise and upward towards the mandrel head 100. The u-bend reversing fitting 54 is positioned at the start of the helix near the mandrel toe 102 with descending pipe 46 and ascending pipe 56 wrapping in a clockwise direction and upwards around mandrel 101 and terminating at GHE pipe inlet 42 and GHE pipe outlet 60. An anchor ring 72 is centre located to the mandrel toe and has anchor tie downs 78 so that descending pipe 46 and ascending pipe 56 can be tied to anchor ring 72 with multi-loop tie 82. Multi-loop tie 82 wraps around and is permanently secured to anchor tie down 78 with locking clip 80. The mandrel alignment tabs 75 are aligned and inserted into the anchor alignment notches 76 to prevent the ring anchor 72 from moving laterally during inserting of the assembly into the ground. Other variations not shown of the spiral basket GHE 300 can be configured such as the same configuration but with the u-bend GHE 34 on the mandrel inside 217 or have two u-bend GHEs 34 with one on the mandrel outside 218 as show and one on the mandrel inside 217 or have a mandrel cut out made so that u-bend reversing fitting 54 can pass from the mandrel outside 218 to the mandrel inside 217 and have descending pipe 46 spiral down to u-bend reversing fitting 54 on the mandrel outside 218 and have ascending pipe 56 spiral up from u-bend reversing fitting 54 on the mandrel inside 217. Referring to FIG. 15E, the multi-loop tie 82 is shown taught but is assembled loose and can be made in various ways from various materials to allow for easy assembly of the u-bend GHE 34 onto the mandrel 101 with anchor ring 72 prior to installing into the ground. The multi-loop tie seam 83 can be made with two straps/cables/ropes/etc. after the pipes are located by sewing, heat sealing, knotting, or using standard buckles or seals used with industrial shipping metal and plastic strapping systems etc.

FIG. 15F shows the spiral basket GHE 300 as it would be installed into the ground with the mandrel removed and ground 6 supporting the spiral basket GHE's 300 shape. The spiral basket GHE's 300 shape in the ground 6 is obtained during its installation into the ground by the mandrel and during the removal of the mandrel. As the u-bend GHE 34 loaded mandrel 101 in FIG. 15A is installed into the ground 6, the ring anchor open area 86 of ring anchor 72 and the inside of hollow mandrel 101 allow the ground 6 to flow in, the ground also flows around the circumferential outside of the loaded assembly and the friction force of the ground 6 on the descending pipe 46 and ascending pipe 56 causes them to slide up the mandrel outside 218 until multi-loop ties 82 which are connected to anchor tie downs 78 become taught spreading out the pipes a distance limited by the size of the loops.

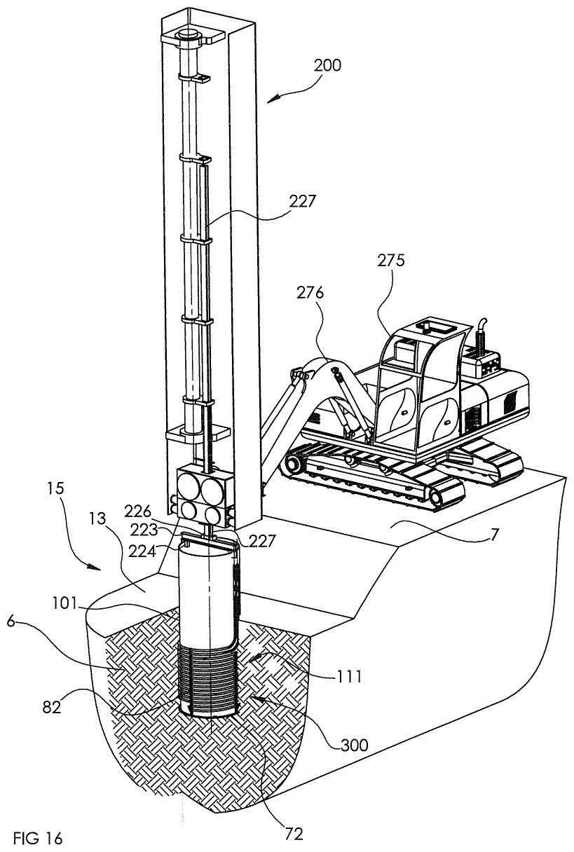

FIG. 16 shows a perspective view of a GHE installer head 200 mounted to mobile equipment's 275 installing a spiral basket GHE 300 into the ground 6. Dugout 15 is made in the ground 6 to a designed elevation below the ground surface 7 for the dugout bottom 13 which is just above the final elevation where the top of the spiral basket GHE 300 is to be. The dugout 15 is made first because the combined cross-sectional area of CET 111 with basket GHE 300's pipe is such that it cannot be driven as far into the ground as an assembly with smaller cross-sectional area. GHE Installer head 200 attached to adjustable boom 276 attached to mobile equipment 275 has inserted mandrel 101 with GHE pipe into the ground 6 to form spiral basket GHE 300. Because mandrel 101 is too large to pass through installer head 200 a mandrel beam driver 227 is used. The mandrel beam driver 227 is fixed to mandrel beam 223 and mandrel 101 by mandrel beam driver clamp 226 and mandrel beam mandrel clamp 224 respectively allowing both vibratory and positive driving forces to be exerted on CET 111 to insert it into the ground 6 and then extract mandrel 101 completing the installation.

The spiral basket GHE's 300 shape in the ground 6 is obtained during its inserting into the ground where the ground can flow around ring anchor 72 inside and outside of mandrel 101 creating friction between the GHE pipes and the ground making them slide up mandrel 101 causing multi-loop tie 82 to go taught thus forming the spiral basket shape.

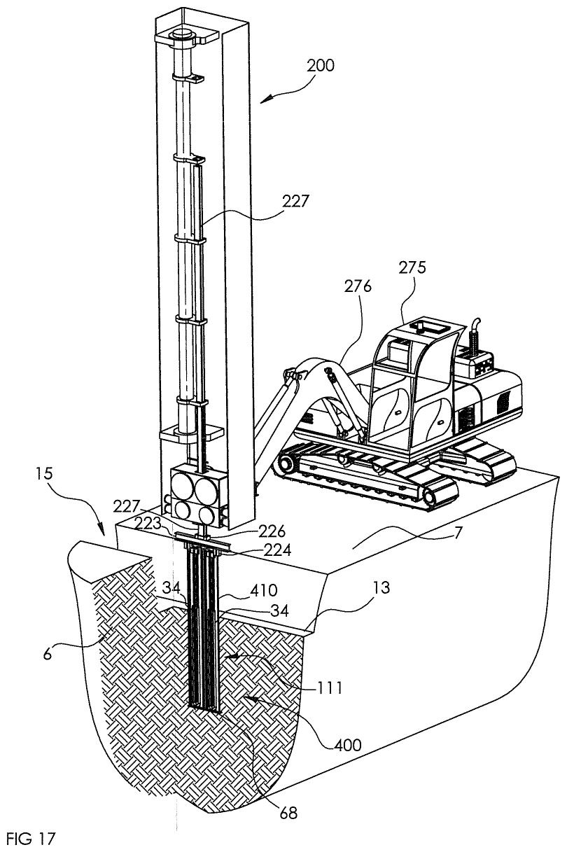

FIG. 17 shows a perspective view of a GHE installer head 200 mounted to mobile equipment's 275 installing a planar multi-u-bend GHE 400 into the ground 6 using CET 111. For this installation, dugout 15 is made in the ground 6 to a designed elevation below the ground surface 7 for the dugout bottom 13 which is just above the final elevation where the top of the plainer multi-u-bend GHE 400 is to be. GHE Installer head 200 attached to adjustable boom 276 attached to mobile equipment 275 has inserted CET 111's corrugated channel mandrel 101 with two u-bend GHEs 34 mounted to it into the ground 6 to form plainer multi-u-bend GHE 400. Because corrugated channel 410 is too large to pass through installer head 200 a mandrel beam driver 227 is used. The mandrel beam driver 227 is fixed to mandrel beam 223 and corrugated channel mandrel 101 by mandrel beam driver clamp 226 and mandrel beam mandrel clamp 224 respectively allowing both vibratory and positive driving forces to be exerted on mandrel 101 to insert and extract it into and out of the ground 6.

Since various modifications can be made in my invention as herein above described, and many apparently widely different embodiments of same made within the spirit and scope of the claims without departing from such spirit and scope, it is intended that all matter contained in the accompanying specification shall be interpreted as illustrative only and not in a limiting sense.

1. A method for installing a ground heat exchange pipe in ground comprising:
using a drive mechanism including an elongate drive mandrel for driving a portion of heat exchange pipe in a generally downward direction into the ground;
engaging and carrying the heat exchange pipe by an inserting tool connected to the drive mandrel as the portion of heat exchange pipe is driven into the ground;
where the inserting tool carries the portion of heat exchange pipe into the ground during its installation;
where the mandrel of the drive mechanism engages the inserting tool carrying the heat exchange pipe and drives the inserting tool into the ground to a finite depth then extracts the mandrel for reuse on the next installation leaving the inserting tool behind with the heat exchange pipe.

2. (canceled)

3. The method according to claim 1 wherein the inserting tool is driven into unbroken ground without requirement for a pre-formed hole and wherein the inserting tool includes components engaging the heat exchange pipe and protecting it from damage as the heat exchange pipe is driven into the ground.

4. The method according to claim 1 wherein the mandrel of the drive mechanism and the reusable inserting tool are connected to one another during the driving into the ground working together to install heat exchange pipe.

5. The method according to claim 1 wherein the mandrel is the same length as the install depth of the heat exchange pipe.

6. The method according to claim 1 wherein there is provided a pipe dispensing device which carries and dispenses heat exchange pipe onto the inserting tool in a controlled fashion.

7. The method according to claim 6 wherein the pipe dispensing device includes two supplies to supply ascending and descending pipe portions respectively in parallel position as the mandrel is driven into the ground.

8. The method according to claim 7 wherein the drive mechanism, the pipe dispensing device and the mandrel are mounted together to form an installer head that is mounted onto a driver head.

9. The method according to claim 1 wherein the inserting tool includes an anchor which has a front head which is forced into the ground and protects leading parts of the heat exchange pipe from abrasive damage caused from passing through the ground.

10. The method according to claim 1 wherein the mandrel includes guides engaging and protecting the trailing heat exchange pipe as the pipe moves into the proper position in the ground.

11. The method according to claim 1 wherein the heat exchange pipe includes ascending and descending portions with a u-bend coupling at the inserting tool.

12. The method according to claim 1 the mandrel includes guides comprise side walls defining guide channels for the descending and ascending pipe portions.

13. The method according to claim 11 wherein the inserting tool includes a tie for attachment to the bottom u-bend coupling of the heat exchange pipe.

14. The method according to claim 1 wherein the heat exchange pipe is inserted to a depth where the heat exchange pipe has an inlet/outlet above the ground surface for connection to header pipes to and from a pump.

15. The method according to claim 1 wherein the mandrel is a rigid elongate member that has a leading mandrel toe for releasable attachment to the inserting tool and a trailing mandrel head for engagement with and receiving driving forces from a drive head.

16. The method according to claim 15 wherein the drive head includes a vibratory hammer.

17. The method according to claim 1 wherein the mandrel has a cross-sectional shape which is sized and configured to have a shank spacer that maintains a shank distance between the descending pipe and the ascending pipe during the inserting of the inserting tool and extraction of the mandrel.

18. The method according to claim 1 wherein the mandrel has a cross-sectional shape configured to allow the heat exchange pipe to placed inside the mandrel whereby the mandrel outside surface is the only surface in contact with the ground thus shielding the heat exchange pipe from the ground during inserting.

19. The method according to claim 1 wherein the mandrel is arranged to clamped at any point along its length and step driven by the drive head so that the drive head is clamped at a starting position for an initial driving stroke, unclamped from the mandrel and moved to carry out series of strokes driving the inserting tool into or out of the ground.

20. The method according to claim 1 wherein the mandrel toe has raised portions of the mandrel toe perimeter to provide mandrel alignment tabs that align with and fit into notches or cut-outs in the inserting tool where the anchor alignment notches, and the mandrel alignment tabs align the anchor to the mandrel and prevent any lateral movement of the anchor during inserting of the inserting tool.

21. The method according to claim 1 wherein the mandrel has a hollow cross section can be used to carry a lubricant or high-pressure cutting fluid or which can also be used to pump grout in the installation during the mandrel extraction,

22-27. (canceled)
